(19) United States
(12) Patent Application Publication
(10) Pub. No.: US 2025/0049083 A1
(43) Pub. Date: Feb. 13, 2025

(54) METHODS FOR INFILTRATING SWEET INGREDIENTS OR USEFUL INGREDIENTS FOR HUMAN BODY INTO FRUITS OR VEGETABLES AND APPARATUS USED IN THE METHODS

(71) Applicants: Chang-Eun YEO, Seoul (KR); Wonsuk CHOI, Gyeryong-si, Chungcheongnam-do (KR)

(72) Inventors: Chang-Eun YEO, Seoul (KR); Wonsuk CHOI, Gyeryong-si, Chungcheongnam-do (KR)

(21) Appl. No.: 18/697,438

(22) PCT Filed: Oct. 26, 2022
(86) PCT No.: PCT/KR2022/016470

§ 371 Date: Mar. 29, 2024

(30) Foreign Application Priority Data
Jan. 1, 2022 (KR) 10-2022-0000025

(51) Int. Cl. A23L 19/00; A23L 27/30; A23L 33/10; A23N 15/06

(52) U.S. Cl. CPC A23L 19/03; A23L 27/36; A23L 33/10; A23N 15/06

(57) ABSTRACT

The present invention relates to methods for processing fruits or vegetables such that sweet ingredients or ingredients useful to the human body effectively infiltrates into fruits or vegetables and to apparatus used in the method. The present invention relates to methods for allowing sweet ingredients or ingredients useful to the human body to be effectively absorbed into fruits or vegetables while supplying fruits or vegetables to the inside of a pressure chamber, reducing the inside of the pressure chamber to low vacuum state within a specific pressure range while all fruits or vegetables to be processed are immersed in aqueous solution of a useful ingredient, maintaining the condition for a set period of time, and returning the inside of the pressure chamber to atmospheric pressure. The present invention relates to methods using only subatmospheric pressure so as to allow sweet ingredient or ingredient useful to the human body to effectively infiltrate into fruits or vegetables while minimizing damage to the skin or the internal tissues of the fruits or vegetables and to apparatus used in the method.

### TECHNICAL FIELD

The present invention relates to method of processing fruits or vegetables through which sweet ingredients or useful ingredients for the human body effectively infiltrate into fruits or vegetables, and to apparatus used in the method.

The present invention relates to methods which allows sweet ingredients or useful ingredients for the human body to be effectively absorbed into fruits or vegetables by performing processes in which, after the fruits or vegetables are supplied into pressure chamber, the internal air of the pressure chamber is depressurized for it to enter a low vacuum state in a range of specific pressure, and the inside is returned to atmospheric pressure. In particular, the present invention relates to methods which minimizes damage to the epidermis or internal tissues of fruits or vegetables and also allows sweet ingredients or useful ingredients for the human body to effectively infiltrate into the fruits or vegetables by performing processes in which the fruits or vegetables to be processed are completely immersed in aqueous solution of the useful ingredients. The internal air of pressure chamber is depressurized to enter low vacuum state and then is restored to atmospheric pressure. The present invention also includes configurations of apparatus used to perform the method above.

### BACKGROUND ART

Even in the past, there have been technologies related to methods and apparatus for strengthening the sweet taste of fruits or vegetables or infiltrating useful ingredients such as medicinal ingredients or fruit flavors into fruits.

1. First, Korean Registered Patent No. 10-1492889 (published on Feb. 12, 2015) discloses an invention titled “method of producing fruits including apples processed through a pressure difference method (hereinafter referred to as “Related Art 1”).” Related Art 1 is for allowing infiltration materials to infiltrate tissues of fruits through a pressure difference method after selecting and dissolving the infiltration materials, which include medicinal ingredients, edible ingredients, fragrance ingredients, and coloring ingredients, in water or edible solvent, and then spraying the infiltration materials onto fruits put into a pressure tank using a sprayer.

In Related Art 1, after plurality of apples are loaded into the pressure tank and then maintained in vacuum state for 90 seconds to expand the apples, infiltration materials are sprayed into the tank using a sprayer. Compressed air at pressure of 1.1 atm to 5 atm is supplied to compress the internal air of the tank and maintained for 50 seconds to infiltrate the infiltration materials into the apples, and then the internal air of the pressure tank is depressurized and maintained for 10 seconds (pressurizing and decompressing process)—this procedure is performed five times.

Related Art 1 relates to a technology in which the air pressure inside the pressure tank is adjusted and the infiltration materials are sprayed onto fruits (apples) exposed in the air to allow the infiltration materials to infiltrate the fruits. Related Art 1 discloses that a vacuum state is used, but it does not disclose specific technical details such as the range of vacuum applied. In addition, Related Art 1 discloses a technology of spraying the infiltration materials onto the fruits (apples) exposed in the internal air while maintaining the inside of the pressure tank in a vacuum state, thereby allowing the infiltration materials to infiltrate the apples. However, Related Art 1 does not disclose specific technical details regarding a vacuum state applied thereto, that is, a range of vacuum pressure or the like.

2. In addition, Korean Public Patent Publication No. 10-2020-0069855 (published Jun. 17, 2020) discloses an invention titled “method of producing peach-flavored tomatoes (hereinafter referred to as “Related Art 2”).” Related Art 2 relates to the following technology: to infiltrate peach flavor or vitamin solution into tomatoes, the tomatoes are loaded into pressure tank to maintain the pressure tank in vacuum state for a certain time and thus expand the tomatoes, and then air is discharged to restore the tomatoes to the original state, after which infiltration solution (mixture of peach flavor and purified water that is dissolved) is sprayed using sprayer installed inside the pressure tank, and then pressurizing and depressurizing process is performed on the internal air of the pressure tank three times to allow the infiltration solution to infiltrate the tomatoes.

Related Art 2 discloses contents in which, after the infiltration solution is sprayed using the sprayer installed inside the pressure tank, compressed air at pressure of 2.2 atm to 2.8 atm is supplied to the pressure tank to pressurize the internal air for 35 seconds and then maintained at pressurized state for 55 seconds. The infiltration solution is infiltrated into an infiltration space formed between the surface and the inside of the tomato, and a depressurizing process of discharging air in the pressure tank for 100 seconds is performed to then maintain the infiltration solution for 18 seconds and to stabilize the infiltration solution. Afterwards, the infiltration solution is supplied again to the pressure tank to perform the pressurizing, depressurizing, and stabilizing processes three times, thereby infiltrating the infiltration solution into the tissues of the tomatoes.

Related Art 2 discloses that the infiltration solution is sprayed onto the tomatoes exposed in the air inside the pressure tank and that the pressure tank is maintained in vacuum state, but it does not disclose specific technical details regarding the vacuum state. Therefore, it is regarded that Related Art 2 corresponds to a technology of which technical content is unclear.

3. Korean Registered Patent No. 10-2188356 (published on Dec. 8, 2020) discloses an invention related to “a method of strengthening sweetness taste of fruits or vegetables, and fruits or vegetables with strengthened sweet taste through the method (hereinafter referred to as “Related Art 3”).” The invention relates to a technology for strengthening the sweet taste of fruits or vegetables using sweet taste strengthening apparatus 100 and relates to a technology including a stage of loading fruits or vegetables that are targets of which sweet taste is to be strengthened, stevioside spraying stage, vacuum maintenance stage, and target unloading stage, wherein a cycle of the stevioside spraying stage and the vacuum maintenance stage are performed 3 to 12 times to infiltrate stevioside into the targets.

Related Art 3 discloses contents in which the stevioside is infiltrated in high vacuum state (1×10⁻⁵ bar to 1×10⁻³ bar) or a high pressure state (1×10³ bar to 1×10⁵ bar) as shown below.

That is, Related Art 3 discloses a method of infiltrating stevioside into fruits or vegetables by performing a stevioside spraying stage (performed for 40 to 60 seconds) and a vacuum maintenance stage (performed for 120 to 140 seconds) 3 to 12 times. In the stevioside spraying stage, stevioside (a sweet taste strengthening ingredient) is sprayed onto fruits or vegetables in a state in which the internal pressure of the sweet taste strengthening apparatus 100 is in the range of 0.2 to 0.7 bar and in the vacuum maintenance stage (performed for 120 to 140 seconds) in which the spraying is stopped, and the internal pressure of the apparatus is maintained in vacuum state in the range of 1×10⁻⁵ to 1×10⁻³ bar.

In addition, Related Art 3 also discloses a method of using high pressure which is completely different from the aforementioned vacuum state (1×10⁻⁵ to 1×10⁻³ bar). That is, Related Art 3 discloses contents in which stevioside spraying stage (performed for 40 to 60 seconds) and a pressure maintenance stage (performed for 120 to 140 seconds) are formed 3 to 12 times to infiltrate stevioside into fruits or vegetables, wherein, in the stevioside spraying stage, the stevioside is sprayed onto the fruits or vegetables in a state in which an internal pressure of the sweet taste strengthening apparatus 100 is in the range of 0.2 to 0.7 bar, and in the pressure maintenance stage, the spraying is stopped and then the internal pressure of the apparatus is maintained in a state of 1×10³ to 1×10⁵ bar.

4. In addition, as another Related Art, Korean Registered Patent No. 10-2245079 (published on Apr. 26, 2021) relates to “food manufacturing device and method for injecting additives into food using vacuum (hereinafter referred to as “Related Art 4”).” Related Art 4 is directed to providing a food manufacturing device and method for injecting additives into food in which active ingredients are infiltrated into foods such as fruits to improve sugar content or to allow other functional ingredients to be ingested, and even when the external temperature rises, it is possible to prevent the discharge of impregnated active ingredients (this appears to denote a state in which the active ingredients are inserted into the food).

Related Art 4 relates to a technology using a first vacuum chamber and a second vacuum chamber accommodated inside the first vacuum chamber, a technology that includes the following stage: after the air inside the first and second vacuum chambers is suctioned until the first vacuum pressure is reached, space between the first vacuum chamber and the second vacuum chamber is blocked and the air inside the second vacuum chamber is suctioned until the second vacuum chamber contains air pressure lower than that in the first vacuum chamber; when the inside of the second vacuum chamber is at a pressure between the first vacuum pressure and the second vacuum pressure, additives are supplied into the second vacuum chamber for a certain time to inject the additives to food. In Related Art 4, when the inside of a second vacuum chamber 102 is at a pressure between the first vacuum pressure and the second vacuum pressure (vacuum gauge pressure of 40 to 100 Torr), the additives are injected into the second vacuum chamber 102 in the form of mist to allow the additives to be injected into the food.

Device of Related Art 4 operates to discharge the air inside the second vacuum chamber until the internal pressure of the second vacuum chamber changes from the first vacuum pressure (40 Torr) to the second vacuum pressure (100 Torr). Related Art 4 relates to a technology in which, while the pressure inside the second vacuum chamber is at a vacuum gauge pressure of 40 to 100 Torr, the additives are sprayed into the second vacuum chamber in the form of mist to allow the additives to be injected into the food.

Thus, Related Art 4 relates to a technology in which, during a time for which the second vacuum pump operates such that the pressure inside the second vacuum chamber starts from the first vacuum pressure and reaches the second vacuum pressure, the additives are sprayed into the second vacuum chamber in the form of mist to allow the additives to be injected into the food.

5. Meanwhile, prior to the present application, the present applicant has applied for a patent for an invention titled “method of infiltrating sweet ingredients or useful ingredients for the human body into fruits or vegetables (hereinafter referred to as “Earlier Application”).

In the Earlier Application (Korean Patent Application No. 10-2021-0026787, filed on Feb. 26, 2021), after an immersion tank that contains only fruits or vegetables is transferred into a pressure chamber, the pressure chamber is sealed to block the air flow from the exterior. Then, in a state in which air is discharged from the inside of the pressure chamber to allow the interior to enter a low vacuum state of 10 to 500 mbar, the low vacuum state is maintained for a certain time. In the low vacuum state formed previously, aqueous solution of useful ingredients is supplied into the pressure chamber to allow all of the fruits or vegetables to be immersed in the aqueous solution of the useful ingredients, and then the low vacuum state is maintained for a certain time. After performing this stage, compressed air is supplied into the pressure chamber in the low vacuum state to pressurize the internal air of the pressure chamber such that a pressure in a certain range is reached, and the pressure is maintained for a certain time. Then the air inside the pressure chamber is discharged to allow the internal pressure to reach atmospheric pressure, and then the atmospheric pressure is maintained for a certain time.

Then, the Earlier Application discloses a method in which compressed air is supplied again into the pressure chamber in an atmospheric pressure state to pressurize the internal air of the pressure chamber such that the pressure reaches a pressure in a certain range, and then the pressure is maintained for a certain time, after which air is discharged to allow the pressure to reach atmospheric pressure, which gets maintained for a certain time. This process is performed one to nine times. In the Earlier Application, the internal air of the pressure chamber is pressurized to a pressure of 1.1 to 100 bar, and a retention time of 10 seconds to 5 minutes is given for each processing stage.

### DISCLOSURE

### Technical Problem

Related arts described above disclose contents related to a technology in which a pressure inside a pressure chamber (referred to as a pressure tank, a vacuum chamber, or the like) is allowed to reach a vacuum or pressurized state to allow sweet taste strengthening ingredients, fragrance ingredients, or medicinal ingredients into fruits or vegetables.

In most of the related arts described above, fruits or vegetables are accommodated inside a pressure tank or container to allow sweet taste strengthening ingredients or medicinal ingredients into the fruits or vegetables and in a state in which the fruits or vegetables are exposed in the air inside the pressure tank, of which pressure is increased or reduced to allow the sweet taste strengthening ingredients or medicinal ingredient to infiltrate the fruits or vegetables. In addition, medicinal ingredients or the like are sprayed onto fruits or vegetables exposed to air inside the pressure tank using a sprayer or are sprayed in the form of mist to allow strengthening ingredients or medicinal ingredients to come in contact with the fruits or vegetables and to be absorbed into the fruits or vegetables.

In the related arts described above, a vacuum treatment method is used but contents related to a specific vacuum degree applied to the method are not disclosed. In fact, a third party cannot implement the technologies disclosed in related arts (Related Arts 1 and 2), or there is a technology (Related Art 3) that has problems; the inside of the pressure tank is allowed to reach an excessively high vacuum state (1×10⁻⁵ to 1×10⁻³ bar) or an excessively high pressure state (1×10³ to 1×10⁵ bar) which damages the epidermis or internal tissues of fruits or vegetables exposed in the air and simultaneously requires excessive use of energy.

In addition, there is also a related art (Related Art 4) in which a vacuum-related pressure is used, and additives are injected in a too low vacuum state (vacuum gauge pressure of 40 to 100 Torr), and thus it is regarded that a vacuum effect rarely occurs or an additive infiltration effect does not actually occur.

Meanwhile, in the Earlier Application filed by the present applicant, in a process of performing a pre-processing process, after an immersion tank in which only fruits or vegetables are contained is transferred into a pressure chamber, the pressure chamber is sealed to discharge air inside the pressure chamber, allow the inside to enter a low vacuum state of 10 to 500 mbar, and then maintain the low vacuum state for a certain time (10 seconds to 5 minutes), and then useful ingredients are supplied into the pressure chamber to allow the fruits or vegetables to be immersed in an aqueous solution of the useful ingredients and then change a pressure inside the pressure chamber to a low vacuum in a certain range and a pressurized state in a certain range, thereby allowing the useful ingredients to infiltrate into the fruits or vegetables. The Earlier Application relates to a technology in which a stage, in which the inside of the pressure chamber is allowed to enter a low vacuum state in a state in which an aqueous solution is not supplied into the pressure chamber, is performed, and then the inside is pressurized to allow useful ingredients to infiltrate into fruits or vegetables.

The Earlier Application uses a method in which an aqueous solution of useful ingredients is not supplied. Instead, fruits or vegetables are first taken into the pressure chamber, and then the interior is allowed to enter a low vacuum state in a certain range (10 to 500 mbar). In addition, a pressure in the low vacuum state is in a very wide range, and after low vacuum processing is performed, a stage of injecting air into the pressure chamber to pressurize the internal air is performed.

In the case of the Earlier Application, a quite long retention time (10 seconds to 5 minutes) is given whenever most processing stages are performed. Therefore, in the Earlier Application, it takes a long time for the useful ingredients to infiltrate into fruits or vegetables, which may also increase processing costs. In addition, a low-vacuum processing process is performed in a state in which fruits or vegetables are exposed in the air, and then a stage of pressurizing the internal air of a pressure chamber is performed, and thus there is a possibility that damage to tissues of target fruits or vegetables may occur due to a large change in pressure during all of processing stages.

The present invention is directed to providing a technology capable of enabling sweet ingredients or useful ingredients for the human body to infiltrate into fruits or vegetables more effectively as compared to related arts or the Earlier Application.

The present invention is also directed to providing a method of allowing all stages to be performed in a state in which fruits or vegetables are completely immersed in an aqueous solution, considerably shortening the processing time, and allowing useful ingredients to effectively infiltrate the fruits or vegetables.

The present invention is also directed to providing a method of processing useful ingredients to effectively infiltrate the fruits or vegetables even without the use of a pressurizing method unlike some related arts and the Earlier Application.

The present invention is also directed to providing a technology for processing fruits or vegetables using a vacuum state in a specific range in which an effect of infiltrating useful ingredients is excellent, and simultaneously to providing a method in which, while a maintenance time applied between processing stages is not given or is given very shortly, useful ingredients for the human body are allowed to effectively infiltrate the fruits or vegetables, thereby considerably shortening the processing time as well as costs as compared to related arts as well as the Earlier Application.

Meanwhile, since most preferred fruits or vegetables include useful ingredients for the human body, when the fruits or vegetables are ingested, beneficial nutrients are supplied. In particular, only when fruits or vegetables should be ingested in a fresh state, the fruits or vegetables can yield more beneficial effects on the human body.

The present invention relates to a technology applied to fresh fruits or vegetables and is directed to improving the sweet taste inside fruits or vegetables or to allowing useful ingredients for the human body to infiltrate the fruits or vegetables, wherein, when a processing time for the useful ingredients to infiltrate is increased, there is a greater possibility that the epidermis or internal tissues of the fruit or vegetable are deformed or damaged. The present invention is also directed to providing a method in which, while useful ingredients are allowed to infiltrate the fruits or vegetables for a short time, damage to the epidermis or internal tissues of the fruits or vegetables is minimized, thereby maintaining the freshness of the fruits or vegetables for a longer period of time as compared to related arts or the Earlier Application.

### Technical Solution

The present invention relates to a method of making the infiltration of sweet ingredients or useful ingredients for the human body into fruits or vegetables effective using apparatus including a pressure chamber 10 configured to adjust a pressure therein, and apparatus used in the method.

The apparatus used in the present invention includes a pressure chamber 10, and the pressure chamber 10 is configured to accommodate one or more immersion tanks 20 in which fruits or vegetables are contained. A pressure cover 11 configured to open and close the pressure chamber is provided on the top, side, or the front.

The pressure cover 11 is configured to open or seal the pressure chamber and is for, when opened, allowing fruits or vegetables to be processed and the immersion tank 20 to be taken into the pressure chamber. After processing them, the immersion tank can be taken out. The pressure cover 11 should be configured to block air flow between the inside and the outside of the pressure chamber when sealed and to prevent leakage of an aqueous solution during processing.

The immersion tank 20 is configured to contain fruits or vegetables therein and move the fruits or vegetables. In addition, the immersion tank 20 is for allowing the fruits or vegetables contained therein to be immersed in an aqueous solution of useful ingredients. The immersion tank may have a shape similar to a cross-sectional shape of the pressure chamber 10 or may have another shape that can be easily transported therein. The immersion tank 20 may be constructed in a way that the sides and the bottom are sealed and may have many holes formed in the sides such that an aqueous solution of useful ingredients can freely flow. The immersion tank may include a separate component to allow all of the fruits or vegetables contained therein to be immersed in an aqueous solution of useful ingredients without floating above the water surface.

The pressure chamber 10 applied to a method of the present invention is configured to accommodate one or more immersion tanks 20. In performing a stage of infiltrating useful ingredients for the human body into fruits or vegetables according to a method of the present invention, all of the fruits or vegetables contained inside the immersion tank should be immersed in the aqueous solution of the useful ingredients, and a space in which air exists should be formed above the aqueous solution.

The present invention can be implemented using apparatus including a vacuum pump 40 that discharges air inside the pressure chamber 10 to the outside and an air pump 30 that supplies external air into the pressure chamber.

Meanwhile, the apparatus applied to the present invention may also be constituted by omitting the air pump 30. In this case, the apparatus operates such that external air is allowed to flow into the pressure chamber through an air inflow pump 35 instead of the air pump and allow pressure inside the pressure chamber to reach atmospheric pressure. The stages of the pumps and air valves may be controlled through a control unit 70 separately provided or may be controlled manually.

Apparatus applied to a method of the present invention includes an aqueous solution storage tank 50 for storing an aqueous solution of useful ingredients, a solution supply pump 60 and a solution supply valve 61 for supplying the aqueous solution of the useful ingredients into an immersion tank or pressure chamber.

When stages according to a method of the present invention are performed using apparatus including such components, sweet ingredients or useful ingredients for the human body can effectively infiltrate into fruits or vegetables.

A method of the present invention may be classified into a simultaneous transfer method and a sequential supply method according to the order of transferring an immersion tank and supplying fruits or vegetables and an aqueous solution of useful ingredients.

The simultaneous transfer method is a method of taking an aqueous solution of useful ingredients together with fruits or vegetables into a pressure chamber 10 to process them. This method involves opening the over (pressure cover) of the pressure chamber, transferring (bringing in) the immersion tank in which fruits or vegetables and the aqueous solution of the useful ingredients are stored together, then carrying out the subsequent stages.

The sequential supply method is a method in which an aqueous solution, fruits or vegetables, and the immersion tank are taken in or supplied into the pressure chamber 10 (both take-in and solution supply can be referred to as “supplying”), and the order thereof is changed to perform supplying and the subsequent stages. As described below, the sequential supply method may be classified into a later solution supply method, which refers to supplying the aqueous solution in the pressure chamber that already contains fruits or vegetables, and an early solution supply method, which is about bringing in fruits or vegetables in the pressure chamber after filling it with the aqueous solution.

The immersion tank 20 used in the sequential supply method of the present invention is to be one that is formed identically irrespective of the order of solution supply, that is, one that has many holes on the sides or on the bottom. In the present invention, subsequent processing stages are performed in a state in which all fruits or vegetables are completely immersed in an aqueous solution regardless of the order in which the solution is supplied. Processing fruits or vegetables while immersed in an aqueous solution of useful ingredients is an important feature of the present invention.

In the case of the pressure chamber 10 used in the later solution supply method of the sequential supply method, an installation position of a pressure cover 11 may be selected relatively freely. That is, the pressure cover may be installed at one side of a side, front, and the top of the pressure chamber.

Meanwhile, the pressure cover 11 used in the early solution supply method of the sequential supply method should be installed on the upper portion of the pressure chamber 10. In the case of the early solution supply method, an aqueous solution should be first supplied into the pressure chamber, and then fruits or vegetables should be supplied into the pressure chamber so that such a structure may be provided. In this method, the immersion tank is taken into the pressure chamber before or after an aqueous solution is supplied.

As described below, the present invention includes one main stage: after fruits or vegetables and an aqueous solution are supplied into a pressure chamber, the pressure chamber is sealed and air inside the pressure chamber is discharged to allow the inside of the pressure chamber to reach a low vacuum at a specific pressure. After the low vacuum is reached, the inside of the pressure chamber is restored to atmospheric pressure. Such configuration applies to both the simultaneous transfer method and the sequential supply method.

In the present invention, apparatus operates such that, after the inside of a pressure chamber 10 reaches a low vacuum state in a range of specific pressure, maintenance time is omitted and a subsequent stage is performed immediately (maintenance time of 0 seconds) or after the low vacuum state is maintained for a certain time, that is, less than 10 seconds. External air is allowed after this step to restore the pressure in the pressure chamber to atmospheric pressure. A vacuum pump 40 for discharging air inside the pressure chamber 10 and an air pump 30 or air inflow valve 35 for supplying air inside the pressure chamber may be operated under the control of a control unit 70 or may be operated manually.

A low vacuum condition at a specific pressure applied to processing the present invention refers to a pressure state of 100 to 500 mbar, but the contents of the present invention also include contents in which a pressure range is further limited to achieve a low vacuum so that the infiltration of useful ingredients is made more effective.

In addition, the present invention, a stage in which, in a state in which fruits or vegetables are immersed in an aqueous solution of useful ingredients, the inside of a pressure chamber reaches a low vacuum in a range of specific pressure and then is restored to atmospheric pressure, is performed one or more times to allow the useful materials to infiltrate into penetrate the fruits or vegetables.

### Advantageous Effects

When a method of the present invention is applied to for sweet ingredients or useful ingredients for the human body to infiltrate into the penetrate fruits or vegetables, the following effects can be expected.

First, in the present invention, all stages of infiltrating sweet ingredients or useful ingredients for the human body into fruits or vegetables are performed in a state in which all fruits or vegetables are immersed in an aqueous solution of useful ingredients. In the case of water, which has a very stable molecular structure, even when a pressure applied to the water changes, there is almost no change in volume thereof. Therefore, when the fruits or vegetables are processed in a state in which all of the fruits or vegetables are immersed in the aqueous solution of useful ingredients, even when the pressure of external air changes, there is almost no change in volume of the fruits or vegetables themselves. Therefore, the fruits or vegetables processed through the method of the present invention can maintain a stable state during a processing stage thereof, thereby effectively preventing damage to tissues.

In particular, in the present invention, by using a low vacuum pressure in a range of specific pressure and not using a high pressure pressurizing stage, as compared to most Related Arts as well as an Earlier Application of the applicant, damage to issues of fruits or vegetables can be prevented. In addition, as a result, damage to the epidermis or internal tissue of fruits or vegetables is minimized, thereby maintaining the freshness of processed fruits or vegetables for a longer period of time as compared to Related Arts.

In the present invention, while a maintenance stage performed after the main processing stage is omitted or performed for a short time of less than 10 seconds, an infiltration effect can be effectively achieved, thereby shortening the time required for processing fruits or vegetables and reducing the processing costs.

### DESCRIPTION OF DRAWINGS

FIG. 1 is a drawing of one embodiment of an apparatus used in the present invention.

FIG. 2 is a drawing of another embodiment of the apparatus used in the present invention.

FIG. 3 is a drawing of another embodiment of the apparatus used in the present invention.

FIG. 4 is a drawing of another embodiment of the apparatus used in the present invention.

FIG. 5 is a graph showing the processing stages of the simultaneous transfer method of the present invention.

FIG. 6 is a graph showing the processing stages of the later solution supply method of the present invention.

FIG. 7 is a graph showing the processing stages according to the early solution supply method 1 of the present invention.

FIG. 8 is a graph showing another embodiment of processing according to the early solution supply method 1 of the present invention.

FIG. 9 is a graph showing the processing stages according to the early solution supply method 2 of the present invention.

FIG. 10 is a graph showing another embodiment of processing stages according to the early solution supply method 2 of the present invention.

### BEST MODES OF THE INVENTION

Among the best modes for carrying out the present invention, a method invention is as follows, as described in Claim 1 of the claims of the present invention.

A method of infiltrating sweet ingredients or useful ingredients for the human body into fruits or vegetables, which is a method of processing fruits or vegetables using an immersion tank 20 of which side surfaces and the bottom are all sealed, wherein the fruits or vegetables are processed in a state of being immersed in an aqueous solution of useful ingredients, includes:
a preparation stage of supplying the aqueous solution of the useful ingredients into the immersion tank 20 such that all of the fruits or vegetables contained in the immersion tank 20 are immersed in the aqueous solution of the useful ingredients,
a taking-in and sealing stage of, after performing the preparation stage, opening a pressure cover 11 of a pressure chamber 10 to take the immersion tank 20, in which all of the fruits or vegetables and the aqueous solution of the useful ingredients are contained into the pressure chamber 10, and then closing the pressure cover 11 to seal the pressure chamber,
a low-vacuum entry stage of, after the taking-in and sealing stage, a vacuum pump 40 to reduce the pressure such that the inside of the pressure chamber 10 enters a low vacuum state in a range of specific pressure,
a low-vacuum maintenance stage of maintaining the vacuum state at the specific pressure, which is reached as a result of performing the low vacuum entry stage for a certain time,
an atmospheric pressure restoration stage of, after the low-vacuum maintenance stage, allowing external air to flow into the pressure chamber 10 to restore the inside of the pressure chamber 10 to an atmospheric pressure state,
an atmospheric pressure maintenance stage of, after performing the atmospheric pressure restoration stage, maintaining a state inside the pressure chamber 10 restored to an atmospheric pressure state for a certain time, and
an opening and taking-out stage of, after performing all stages up to the atmospheric pressure maintenance stage, opening the pressure cover 11 and taking out the immersion tank 20, in which all of the fruits or vegetables and the aqueous solution of the useful ingredients are taken out.

The specific pressure applied to the low-vacuum entry stage ranges from 100 to 500 mbar.

A retention time in the low-vacuum maintenance stage and the atmospheric pressure maintenance stage is in the range of 0 seconds to less than 10 seconds.

The low-vacuum entry stage, the low-vacuum maintenance stage, the atmospheric pressure restoration stage, and the atmospheric pressure maintenance stage are performed once or more.

Among the best modes for carrying out the present invention, apparatus invention is as follows, as described in Claim 18 of the claims of the present invention.

An apparatus, that is used for sweet ingredients or useful ingredients for the human body to infiltrate into fruits or vegetables according to the method described in any one of Claims 1 to 8, includes a pressure chamber 10,
one or more immersion tanks 20 accommodated in the pressure chamber 10,
an air pump 30 or air inflow valve 35 that operates to supply external air into the pressure chamber 10,
a vacuum pump 40 that operates to discharge air inside the pressure chamber 10 and allow the inside of the pressure chamber 10 to enter a low vacuum state in a range of specific pressure,
an aqueous solution storage tank 50 configured to store an aqueous solution of useful ingredients that are to infiltrate into the fruits or vegetables,
a solution supply pump 60 and a solution supply valve 61 configured to supply the aqueous solution stored in the aqueous solution storage tank 50 into the pressure chamber 10,
a pressure gauge 80 configured to display the pressure inside the pressure chamber,
a level sensor 90 configured to indicate the level of the aqueous solution of the useful ingredients supplied to the pressure chamber 10 or the immersion tank 20, and
a drain valve 101 that operates to drain the aqueous solution supplied into the pressure chamber 10.

The solution supply valve 61 is connected to a solution supply nozzle 62 and is configured to supply the aqueous solution of the useful ingredients to each of the immersion tanks 20 accommodated inside the pressure chamber 10.

### MODES OF THE INVENTION

The present invention relates to methods of processing fruits or vegetables to effectively infiltrate into fruits or vegetables ingredients beneficial to the human body that strengthen the sweet taste.

In the present invention, “ingredients that strengthen the sweet taste or are useful to the human body” are also abbreviated and used as “useful ingredients for human body” or “useful ingredients.”

The present invention is particularly applicable to fruits or vegetables such as tomatoes, cherry tomatoes, paprikas, and cucumbers of which tissues are formed to be relatively easy for useful ingredients to infiltrate therein. When the time or number taken in processing the fruits or vegetables are changed, the present invention is also applicable to fruits or vegetables into which the useful ingredients infiltrate relatively slowly.

The present invention relates to a method and apparatus for effectively infiltrating sweet ingredients or useful ingredients for the human body, such as stevioside, sucralose, palm sugar, vitamins, collagen, and fruit flavor, into the aforementioned fruits or vegetables. The present invention uses aqueous solution that is manufactured by dissolving one or more of such useful ingredients in water.

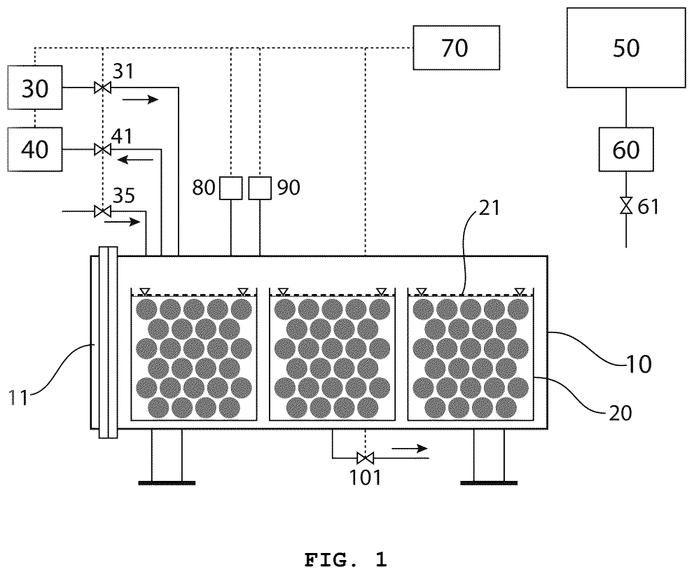

A method of the present invention may be performed using apparatus provided as shown in FIGS. 1, 2, 3, and 4. Hereinafter, the configuration of the apparatus used in the method of the present invention will be described with reference to the drawings, and then the contents of a processing method according to the present invention performed using the apparatus will be described in detail.

FIG. 1 is a drawing of one configuration of apparatus (referred to as an apparatus of the present invention or simply referred to “apparatus”) used to perform the method of the present invention.

The apparatus for infiltrating useful ingredients shown in FIG. 1, which is used in the method of the present invention, is intended to be applied to a simultaneous transfer method in which fruits or vegetables and an aqueous solution of useful ingredients are simultaneously taken into a pressure chamber 10 to perform processing. The apparatus for infiltrating useful ingredients of FIG. 1 may include the pressure chamber 10, one or more immersion tanks 20, an air pump 30, a vacuum pump 40, an air inflow valve 35, a control unit 70, a pressure gauge 80 that displays a pressure inside the pressure chamber, and a level sensor 90 that indicates the level of an aqueous solution of useful ingredients supplied to the pressure chamber 10 or the immersion tank 20. For reference, in the description of the present invention, “aqueous solution of useful ingredients” is also abbreviated as “aqueous solution.”

The simultaneous transfer method is a method in which the immersion tank 20 that contains all of the aqueous solution of the useful ingredient and the fruits or vegetables is transferred into the pressure chamber to perform processing. In operating this method, there is no need to separately supply the aqueous solution of the useful ingredients into the pressure chamber, and thus the apparatus may be constructed simply. Meanwhile, since the immersion tank 20 in which all of the aqueous solution and the fruits or vegetables are contained should be transferred, a load on the immersion tank is relatively heavier as compared to the case of the sequential supply method.

To apply the simultaneous transfer method, the aqueous solution of the useful ingredients stored in an aqueous solution storage tank 50 should be supplied to the immersion tank and then transferred (taken) into the pressure chamber 10. The aqueous solution storage tank 50 may be separately installed, and the aqueous solution of the useful ingredients may be supplied to the immersion tank 20 using a solution supply pump 60 and a solution supply valve 61.

In the case of the simultaneous transfer method, there is no need to directly drain the aqueous solution from the inside of the pressure chamber 10. However, the apparatus may include a drain valve 101 to drain the aqueous solution that flows into the pressure chamber during the procedure or to drain cleaning water sprayed into the pressure chamber for cleaning or the like.

The pressure chamber 10 is a core component for performing the method of the present invention. The pressure chamber 10 should have a sturdy structure that can withstand external pressure, shock, and low vacuum conditions and should be sealed from the outside. The pressure chamber 10 may be configured to accommodate one or more immersion tanks 20 therein. The pressure chamber may have a cylindrical shape, a rectangular parallelopiped, or the like.

A pressure cover 11 is provided at one side of the pressure chamber 10. The pressure cover 11 is configured to open or close the pressure chamber and is for taking the immersion tank 20 into the pressure chamber and taking out the immersion tank 20 to outside after processing is completed. The pressure cover 11 is configured to seal the pressure chamber 10 to allow the inside of the pressure chamber 10 to enter a low vacuum state. The pressure cover 11 may be formed at one side of the top, the front, and the sides of the pressure chamber, and the shape and position thereof may be selected according to the needs of apparatus designer and may be changed according to the direction and method in which the immersion tank is taken in or out.

For embodiment, when the immersion tank 20 is taken in and out through the upper side of the pressure chamber 10, the pressure cover 11 is installed on the upper portion of the pressure chamber. And when the immersion tank 20 is taken in and out through the side of the pressure chamber, the pressure cover is formed on one of the sides of the pressure chamber 10.

The immersion tank 20 is a tank for containing fruits or vegetables to be processed therein and for moving the fruits or vegetables. It also allows the fruits or vegetables contained therein to be immersed in the aqueous solution of the useful ingredients. The upper portion of the immersion tank may be open, and the side cross section may have a shape similar to the cross-sectional shape of the pressure chamber or may have another shape that may be easily transported into the pressure chamber.

The immersion tank 20 used in the present invention may be manifested in mainly two forms: the immersion tank 20 may be formed such that all of the sides and the bottom are sealed or may be formed such that many holes may be formed on the sides or on both the sides and the bottom to allow the aqueous solution of the useful ingredients to flow freely.

Since the side surfaces and bottom of the immersion tank 20 are all sealed, the immersion tank 20 used in the simultaneous transfer method is formed to contain the aqueous solution of the useful ingredients and the fruits or vegetables together therein. The immersion tank having such a form is for processing the fruits or vegetables by transferring (loading) the entire immersion tank into the pressure chamber in a state in which the fruits or vegetables are immersed in the aqueous solution of the immersion tank. In the case of the apparatus used in the simultaneous transfer method, there is no need for a separate component to supply the aqueous solution of the useful ingredients into the pressure chamber.

The immersion tank 20 used in the sequential supply method has the holes formed in the side surface or the side surface and the bottom. When the immersion tank with such form is used, the aqueous solution of the useful ingredients supplied into the pressure chamber flows into the immersion tank through the holes, the fruits or vegetables therein are immersed in the aqueous solution of the useful ingredients, and after processing, the aqueous solution is drained from the immersion tank.

FIG. 1 shows a state in which one or more immersion tanks 20 are taken into the pressure chamber 10, and all of fruits or vegetables contained in the immersion tank 20 are immersed in an aqueous solution.

That is, the pressure chamber 10 of the apparatus applied to the present invention is configured to accommodate one or more immersion tanks 20 therein. An anti-floating portion 21, which is a component for allowing all of the fruits or vegetables contained in the immersion tank 20 to be immersed in an aqueous solution of useful ingredients, may be additionally provided in the immersion tank 20. The anti-floating portion is for preventing the fruits or vegetables from floating on the water surface of the aqueous solution and may be installed to be coupled to or separated from the upper portion of the immersion tank 20.

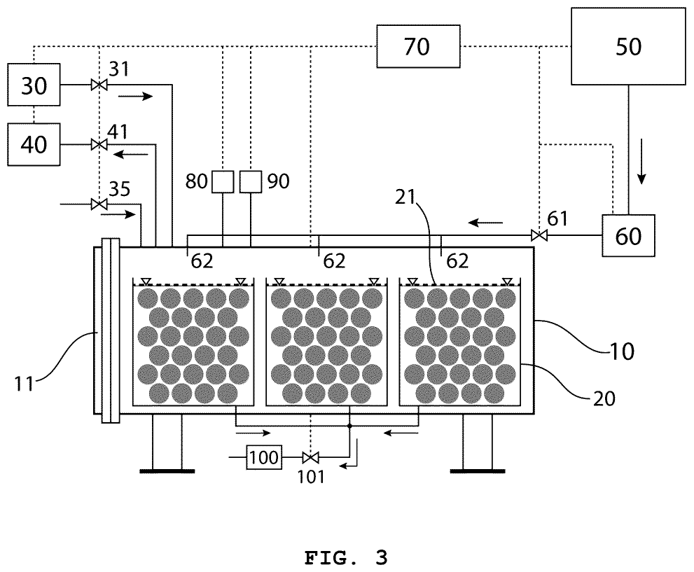

The anti-floating portion 21 is also provided in apparatus shown in FIG. 3. The anti-floating portion 21 is provided at the upper portion of the immersion tank 20, and when an aqueous solution of useful ingredients is supplied above a certain water level, the anti-floating portion 21 prevents fruits or vegetables contained in the immersion tank 20 from floating on water, thereby allowing all of the fruits or vegetables, which are to be processed, to be submerged (immersed) in the aqueous solution of the useful ingredients.

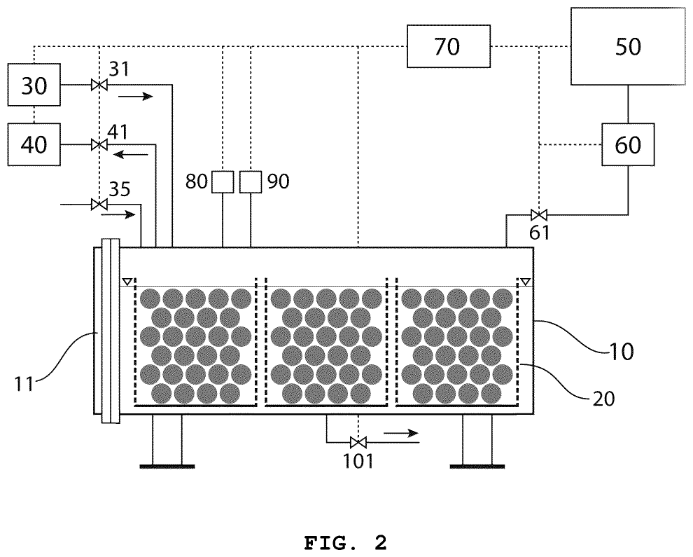

Although the anti-floating portion 21 is not shown in FIG. 2, the anti-floating portion 21 may also be applied to apparatus in FIG. 2.

The air pump 30 used in the present invention is a pump for supplying air into the pressure chamber, and the vacuum pump 40 is a pump for discharging air from the inside of the pressure chamber to lower the internal vacuum state. The air pump 30 and the vacuum pump 40 may operate under the control of the control unit 70.

The present invention relates to a method in which, after air inside the pressure chamber 10 is discharged to allow the internal pressure to reach a low vacuum state in a range of specific pressure, either air is immediately injected into the pressure chamber 10 with no maintenance time to restore (increase) the low vacuum state to atmospheric pressure or the low vacuum state is maintained for a very short time and restored to the atmospheric pressure state, thereby allowing sweet ingredients or useful ingredients for the human body to infiltrate into fruits or vegetables. In this way, one of the important features of the present invention is to allow the interior of the pressure chamber 10, in which fruits or vegetables are accommodated, to reach a low vacuum state in a range of specific pressure and then restore the interior to atmospheric pressure again. In the present invention, since the pressure inside the pressure chamber 10 does not rise above atmospheric pressure, there is no need to use a booster pump.

The vacuum pump 40, the air pump 30, and the air inflow valve 35 may be operated under the control of the control unit or may be manually controlled and operated. In the present invention, one may choose to use both air pump 30 and air inflow valve 35 or may use only one of them. To prevent pressure from being abruptly reduced or to prevent pressure from being abruptly increased to atmospheric pressure, preferably, the vacuum pump 40 and the air pump 30 are used in combination with electronically controlled electromagnetic valves 31 and 41, respectively, and the air inflow valve 35 is also provided in the form of an electromagnetic valve. The electromagnetic valves operate to discharge air inside the pressure chamber or to supply air into the pressure chamber under the control of the control unit 70.

In the case of the simultaneous transfer method using the apparatus according to the configuration of FIG. 1, the aqueous solution storage tank 50 in which an aqueous solution of useful ingredients is stored and the solution supply pump 60 and solution supply valve 61 may be operated separately without being controlled by the control unit 70. In this case, after the aqueous solution of the useful ingredients is supplied from the aqueous solution storage tank 50 to the immersion tank 20, fruits or vegetables may be supplied to the immersion tank 20, and then the immersion tank may be transferred into the pressure chamber 10 to process the fruits or vegetables.

The apparatus according to the configuration of FIG. 2 is used in a later solution supply method of the sequential supply method. In the later solution supply method, after the immersion tank 20 that contains only fruits or vegetables is first transferred (taken) into the pressure chamber 10, the pressure cover 11 is sealed and then an aqueous solution of useful ingredients is supplied into the pressure chamber. The aqueous solution of the useful ingredients is supplied from the aqueous solution storage tank 50 into the pressure chamber 10 through components such as the solution supply pump 60 and the solution supply valve 61. FIG. 2 is a drawing illustrating an embodiment of the apparatus in which the pressure cover 11 is formed at one side of the side surface of a pressure chamber 10.

The apparatus of FIG. 2 includes the pressure chamber 10, one or more immersion tanks 20, the air pump 30, the vacuum pump 40, the air inflow valve 35, the control unit 70, the aqueous solution storage tank 50, the solution supply pump 60 and the solution supply valve 61 for supplying an aqueous solution of useful ingredients and the drain valve 101 for draining the aqueous solution of the useful ingredients used in processing. It further includes the pressure gauge 80 that displays pressure inside the pressure chamber and the level sensor 90 that indicates a level of the aqueous solution of the useful ingredients supplied to the pressure chamber 10 or the immersion tank 20. In the apparatus of FIG. 2, the anti-floating portion 21 formed as described above with reference to FIG. 1 may be provided at the upper portion of the immersion tank 20. The apparatus is also provided such that one or more immersion tanks 20 are accommodated inside the pressure chamber 10.

Unlike the apparatus of FIG. 1, the aqueous solution storage tank 50, the solution supply pump 60, and the solution supply valve 61 for supplying the aqueous solution of the useful ingredients become components of the apparatus shown in FIG. 2 and are provided to operate in combination with other components. The apparatus used in the sequential supply method should include a component for supplying an aqueous solution of useful ingredients into the pressure chamber 10.

The apparatus in FIG. 2 also includes the drain valve 101 which is a valve for draining the aqueous solution of the useful ingredients. The drain valve 101 provided in the apparatus of FIG. 1 is for draining an aqueous solution of useful ingredients leaked into the pressure chamber during processing or draining cleaning water sprayed into the pressure chamber for cleaning or the like, but the drain valve 101 provided in the apparatus of FIG. 2 is for draining the aqueous solution of useful ingredients inside the pressure chamber to outside after the processing of fruits or vegetables is completed. That is, the apparatus used in the sequential supply method should include the drain valve 101. The drain valve 101 may be a component that operates in conjunction with a drain pump (not shown in FIG. 2).

FIG. 3 is a drawing illustrating an embodiment of another configuration of the apparatus applied to the sequential supply method. The apparatus of FIG. 3 further includes a number of solution supply nozzles 62 in addition to the components provided in the apparatus of FIG. 2. The solution supply nozzle 62 is for supplying an aqueous solution of useful ingredients to each immersion tank 20 transferred (taken) into the pressure chamber. The same number of solution supply nozzles 62 as the immersion tanks is provided.

FIG. 3 is a drawing illustrating another configuration of the apparatus that may be used in the sequential supply method.

The apparatus of FIG. 3 is also provided such that one or more immersion tanks 20 are accommodated inside the pressure chamber 10. Even in the case of the apparatus, an immersion tank with multiple holes formed on the sides or on the sides and the bottom used in FIG. 2 may be used, or an immersion tank of which sides and bottom are sealed may be used.

When the immersion tank of which the side surface and bottom are sealed is used, a component for supplying an aqueous solution of useful ingredients to each immersion tank above the immersion tank should be provided. To this end, the solution supply nozzle 62 capable of supplying an aqueous solution to each immersion tank is installed at the upper portion of the pressure chamber 10. The aqueous solution is supplied to the entire interior of the pressure chamber 10 or the inside of each immersion tank 20 through the solution supply pump 60, the solution supply valve 61, and the solution supply nozzle 62.

When using the apparatus of FIG. 3 utilizing the immersion tank with the through-holes formed in the side surface and the bottom to process fruits or vegetables according to the sequential supply method, the aqueous solution may be drained to the outside through the drain valve 101 or through both the drain valve 101 and a drain pump 100 in a drain passage after operating the process.

In other words, the apparatus in FIG. 3 may be regarded as apparatus that is a compromise between the simultaneous transfer method using the apparatus in FIG. 1 and the sequential supply method using the apparatus in FIG. 2. When the apparatus of FIG. 3 is used, the immersion tank 20, which does not contain aqueous solution and is thus relatively light, may be taken into the pressure chamber 10 to process fruits or vegetables, and even after processing, the light immersion tank 20 in which only fruits or vegetables are contained may be taken out, thereby easily performing a transfer stage.

In addition, when the apparatus is used, since an aqueous solution is supplied only to the inside of the immersion tank 20 rather than the entire inside of the pressure chamber 10, there is the advantage of having the amount of aqueous solution of useful ingredient considerably reduced.

Meanwhile, the apparatus of FIG. 3 may use the immersion tank 20 of which the side surfaces and the bottom are all sealed. In this case, when the immersion tank 20 is taken in, the immersion tank 20, in which only fruits or vegetables are contained, is transferred into the pressure chamber, and when the immersion tank 20 is taken out after processing, the immersion tank, in which fruits or vegetables and an aqueous solution are all contained, should be taken outside.

However, the immersion tank 20 in which all of the fruits or vegetables and the aqueous solution are contained, is very heavy, and thus a transfer stage is relatively difficult. Therefore, to solve this problem, preferably, an apparatus is provided such that a component for draining an aqueous solution is provided at a lower end of each of the pressure chamber 10 and the immersion tank 20, and after processing the fruits or vegetables, the aqueous solution inside the immersion tank 20 is drained to the outside of the pressure chamber 10.

In the present invention, by using the apparatus provided as shown in FIGS. 1 to 3, fruits or vegetables are processed according to stages described below. The contents of processing stages according to a method of the present invention may partially differ according to a simultaneous transfer method and a sequential supply method.

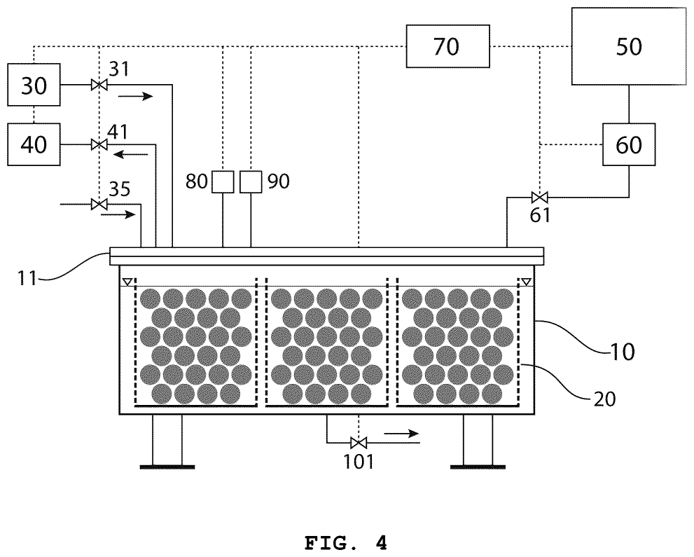

FIG. 4 is a drawing of an embodiment of the apparatus in which the pressure cover 11 is installed on an upper portion of the pressure chamber 10. The apparatus provided in this way may be used in both a simultaneous transfer method and a sequential supply method and may be an apparatus that can be especially applied to an early solution supply method of the sequential supply method. The only difference between the apparatus in FIG. 4 and that in FIG. 2 is the position at which the pressure cover is installed, and the rest of the configurations are identical.

In the apparatus provided as shown in FIG. 4, after the pressure cover 11 is opened, fruits or vegetables and an immersion tank may be supplied through an open upper space. And even after the aqueous solution is supplied, the fruits or vegetables and the immersion tank may be supplied in the same way. In the present invention, since fruits or vegetables are processed at a pressure between a low vacuum pressure (pressure of 100 mbar or more) and atmospheric pressure without applying high pressure or high degree of vacuum, a pressure chamber with a hexahedral shape or a rectangular parallelepiped shape may be used instead of a pressure chamber in a cylindrical shape.

Hereinafter, the contents of a method of processing fruits or vegetables performed in each stage will be described in detail with reference to the drawings.

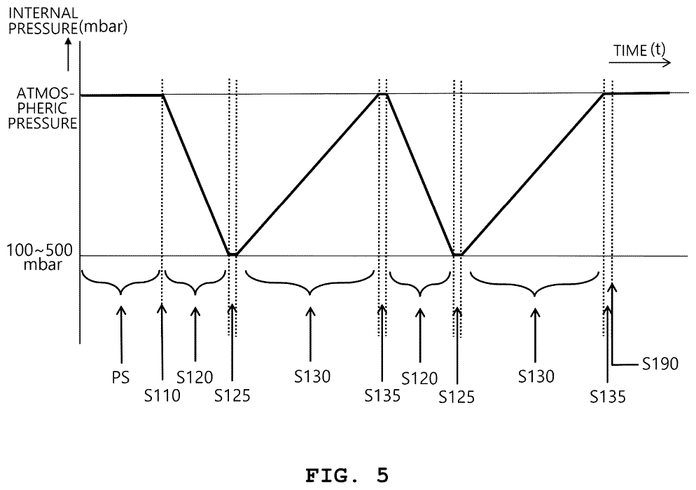

First, a processing method of infiltrating useful ingredients into fruits or vegetables performed in a simultaneous transfer method will be described with reference to FIG. 5.

The simultaneous transfer method is a method performed in a state in which the immersion tank 20 with fruits or vegetables and aqueous solution is transferred into the pressure chamber. Therefore, the immersion tank used in the method should be formed such that all of the sides and the bottom are sealed in a way that the aqueous solution may be stored therein. The simultaneous transfer method includes the following stages.

A start stage of the simultaneous transfer method is a preparation stage (PS) that is a stage of, before transferring the immersion tank 20 into the pressure chamber 10, first putting fruits or vegetables to be processed into the immersion tank, and then supplying an aqueous solution of useful ingredients. In the preparation stage, the aqueous solution of the useful ingredients is supplied from the aqueous solution storage tank 50, which is separately provided, to the immersion tank 20 using the solution supply pump 60 and the solution supply valve 61, and the aqueous solution should be supplied such that all of the fruits or vegetables contained inside the immersion tank 20 are immersed in the aqueous solution. In FIG. 1, the anti-floating portion 21 is provided. When the aqueous solution is supplied until reaching the anti-floating portion 21, all of the fruits or vegetables are immersed in the aqueous solution.

After the preparation stage (PS) is performed, the immersion tank is taken into the pressure chamber 10, and then the following stages are sequentially performed.

Taking-in and sealing stage S110: After the pressure cover 11 is opened, the immersion tank 20 in which all of the fruits or vegetables and the aqueous solution of the useful ingredients are contained is transferred into the pressure chamber 10, and then the taking-in and sealing stage S110 of closing the pressure cover 11 and then sealing the pressure chamber is performed.

Low-vacuum entry stage S120: After the take-in and sealing stage S110, low vacuum entry stage S120 of discharging air inside the pressure chamber to allow the inside of the pressure chamber 10 to enter a low vacuum state in a range of specific pressure is performed. To perform this stage, the vacuum pump 40 starts to operate under the control of the control unit 70, and until the pressure reaches a low vacuum pressure set in the range of specific pressure which is applied to the present invention by an apparatus manager, the vacuum pump discharges air inside the pressure chamber 10. The output power of the vacuum pump 40 may be selected according to the capacity of the pressure chamber.

A low vacuum in the range of specific pressure applied to low-vacuum entry stage S120 of the present invention is a low vacuum in a range of 100 to 500 mbar. Such a pressure range is for limiting the range in which useful ingredients for the human body may effectively infiltrate into the fruits or vegetables even under low vacuum pressure (when expressed as a vacuum gauge pressure, a range of vacuum pressure is from −900 to −500 mbar).

Meanwhile, as described below using results of an experiment conducted by the applicant, the low vacuum pressure applied to the inside of the pressure chamber 10 may be further limited to a range in which an infiltration effect is better. That is, in a range of vacuum pressure applied to the present invention, a more preferable low vacuum pressure range for effectively infiltrating useful ingredients for the human body into fruits or vegetables is from 100 to 400 mbar (vacuum gauge pressure of −900 to −600 mbar). A still more desirable low vacuum pressure range is from 100 to 300 mbar (vacuum gauge pressure of −900 to −700 mbar), and the most desirable low vacuum pressure range is from 100 to 200 mbar (vacuum gauge pressure of −900 to −800 mbar).

In infiltrating useful ingredients into fruits or vegetables according to a method of the present invention, when the range of low vacuum pressure is gradually limited and applied as described above, an effect of infiltrating useful ingredients is better in an additional limited range.

Meanwhile, when a pressure inside the pressure chamber 10 is reduced to be less than 100 mbar to enter a higher vacuum state, an amount of infiltration of useful ingredients increases, but there is a risk of damage to the interior of fruits or vegetables to be processed. Thus, the marketability of products decreases, and the costs and time for operating an apparatus considerably increase, which decreases the overall processing efficiency.

While the aforementioned low-vacuum entry stage S120 is performed, changes such as expansion of the epidermis and internal tissues of fruits or vegetables occur. Thus, during subsequent stages, useful ingredients infiltrate into the fruits or vegetables. That is, as described below, after low-vacuum entry stage S120, low-vacuum maintenance stage S125 and atmospheric pressure restoration stage S130 are performed sequentially. During the atmospheric pressure restoration stage, a particularly large amount of useful ingredients for the human body infiltrate into the fruits or vegetables.

Low-vacuum maintenance stage S125: In the present invention, after a low vacuum state of the specific pressure is reached as a result of performing low-vacuum entry stage S120, low-vacuum maintenance stage S125 of maintaining such a state for a certain time may be performed. This step is to allow extra time for alleviating the impact on tissues of the fruits or vegetables that may occur due to a change in pressure.

As described above, in the present invention, since a low vacuum in a range of 100 to 500 mbar is applied and the low-vacuum entry stage is performed in a state in which all of the fruits or vegetables to be processed are immersed in the aqueous solution of the useful ingredients, tissue changes or impacts rarely occur or in little degrees in the fruits or vegetables.

Therefore, in the present invention, low-vacuum maintenance stage S125 may be omitted or performed only for a short time of less than 10 seconds. Such stage may be omitted, and atmospheric pressure restoration stage S130, which is the next stage, may be performed. Alternatively, after low-vacuum maintenance stage S125 is maintained for a very short time of less than 10 seconds, the next stage may be performed.

Meanwhile, when a long maintenance time is given in such stage, the amount of infiltrated ingredients further increases but the amount of infiltration is insignificant compared to the time, and when the maintenance time is long, the overall processing time increases, considerably decreasing the processing efficiency. In addition, when fruits or vegetables are left in a low vacuum state for a long time, problems such as tissue softening may occur. Therefore, it is desirable that such maintenance stage is performed in a short time range as stated above.

For reference, in an Earlier Application of the applicant, a low vacuum state similar to a low vacuum of the present invention is maintained for a time of 10 seconds to 5 minutes, and even after the inside of a pressure chamber is pressurized to a pressure higher than the atmospheric pressure, the same maintenance time (10 seconds to 5 minutes) is given. While the main stages of infiltrating useful ingredients are to be performed, in the case of the Earlier Application which is constructed in a way that long maintenance time (10 seconds to 5 minutes) is given after each stage is performed, the time taken to process the infiltration of the useful ingredients takes relatively long.

The present invention is derived to make the infiltration of useful ingredients more effective while solving the abovementioned problems of the Earlier Application. The present invention provides a configuration in which the pressure maintenance time after low-vacuum entry stage S120 is omitted or a very short pressure maintenance time (of less than 10 seconds) is applied, and at the same time, a stage in which the air inside the pressure chamber 10 is pressurized to a pressure higher than the atmospheric pressure is not included.

Due to such features, in the present invention, as compared to Related Arts and the Earlier Application, the overall processing time can be shortened, and despite the shortened processing time, useful ingredients can effectively infiltrate into the fruits or vegetables.

Atmospheric pressure restoration stage S130: After low-vacuum maintenance stage S125, atmospheric pressure restoration stage S130 of allowing external air to flow into the pressure chamber 10 to allow the inside of the pressure chamber 10 to be restored to an atmospheric pressure state is performed. In atmospheric pressure restoration stage S130, the control unit 70 operates the air pump 30 to supply external air into the pressure chamber or opens the air inflow valve 35 to allow external air to flow in.

In atmospheric pressure restoration stage S130, the air pressure inside the pressure chamber 10 is restored to atmospheric pressure, and to prevent the pressure from abruptly rising, the air pump 30 and the electromagnetic valve 31 for the air pump may also be used together. The air pump 30 and the electromagnetic valve 31 operate under the control of the control unit 70. The control unit 70 controls the air pump 30 and the electromagnetic valve 31 together such that a pressure inside the pressure chamber 10 rises evenly and gradually to atmospheric pressure, thereby allowing external air to flow in. Alternatively, the control unit 70 adjusts the air inflow valve 35 to allow external air to flow in. The air pump 30 or the air inflow valve 35 may be provided to be manually operated but is preferably provided to include an electromagnetic valve for precise control.

In the present invention, atmospheric pressure restoration stage S130 is the most important core process among the processes of infiltrating useful ingredients into fruits or vegetables. That is, among the various stages included in the method of the present invention, atmospheric pressure restoration stage S130 is a stage in which most of the useful ingredients infiltrate into the fruits or vegetables. During this stage, the tissues of the fruits or vegetables, which are swollen or deformed during the previous low-vacuum entry stage S120 and low-vacuum maintenance stage S125, return (restore) to the original state thereof. Through this stage, the useful ingredients are actively absorbed into the fruits or vegetables.

In atmospheric pressure restoration stage S130, the time taken for air pressure inside the pressure chamber 10 to be restored to atmospheric pressure—atmospheric pressure restoration time—is a very important factor in the process of infiltrating the useful ingredients into fruits or vegetables.

When the restoration time is long in atmospheric pressure restoration stage S130, the stage may be performed only once. This step may be performed multiple times according to an applied atmospheric pressure restoration time and types of fruits or vegetables.

First, to restore the interior of the pressure chamber 10 in a low vacuum state to atmospheric pressure, external air should be supplied using the air pump 30 or the air inflow valve 35. To this end, time (inflow lead time) is required to allow air to flow in. The inflow lead time may vary according to the capacity of the air pump or the type of the air inflow valve, and in the case of an apparatus applied to the method of the present invention, it usually takes at least 30 seconds.

In the present invention, the time taken for performing the atmospheric pressure restoration stage or the atmospheric pressure restoration time is set in the range of 30 seconds to 10 minutes, 30 seconds to 7 minutes, or 30 seconds to 5 minutes to control the amount of the useful materials infiltrating into the fruits or vegetables.

In the present invention, the atmospheric pressure restoration time may be applied differently as follows according to a target or purpose.

First, for fruits or vegetables into which useful ingredients infiltrate relatively easily, atmospheric pressure restoration stage S130 may be performed for 30 seconds to 10 minutes, and for fruits or vegetables which have relatively hard tissues and thus require a longer infiltration time, atmospheric pressure restoration stage S130 may be performed for 30 seconds to 7 minutes and may be performed twice. When other types of harder fruits or vegetables are processed, atmospheric pressure restoration stage S130 may be performed for 30 seconds to 5 minutes and may be performed three or more times.

Next, even when it is necessary to increase the infiltration of useful ingredients into fruits or vegetables, processing may be performed by further increasing the atmospheric pressure restoration time or increasing the number of repetition of atmospheric pressure restoration stage S130. However, when the atmospheric pressure restoration time is too long, problems such as damage or deterioration of tissues of fruits or vegetables may occur. Therefore, when fruits or vegetables are to be processed according to the method of the present invention, it is more effective to apply the time and number of repetition in a range as described above.

Meanwhile, repeating atmospheric pressure restoration stage S130 in this case operates under the condition that the low vacuum restoration entry stage S120 is carried out the same number of times as the atmospheric pressure restoration stage S130. As such, low-vacuum entry stage S120 and atmospheric pressure restoration stage S130 may not be performed separately but atmospheric pressure restoration stage S130 may be performed after low-vacuum entry stage S120 is performed. Therefore, the number of times such stages are performed are the same. To perform such stages multiple times, the control unit 70 should control each component of the apparatus to perform the stages in the corresponding number of times.

In performing atmospheric pressure restoration stage S130, the control unit 70 controls the air pump 30 or the air inflow valve 35 to allow external air to flow into the pressure chamber 10 for a time set above. The pressure inside the pressure chamber 10 is allowed to rise evenly and gradually during the time set above so that the useful ingredients infiltrate into the fruits or vegetables evenly.

When the useful ingredients infiltrate into fruits or vegetables abruptly, the internal structures of the fruits or vegetables may be damaged, which may cause problems such as reduction in storage or distribution period of products. When the air pump 30 is used, it is preferable that through the electromagnetic valve 31, the air pump 30 is operated to allow external air gradually and evenly flow into the pressure chamber 10. Even when the air inflow valve 35 is used, it is preferable that the air inflow valve 35 itself is provided as an electromagnetic valve to allow external air to gradually and evenly flow in the pressure chamber 10.

Atmospheric pressure maintenance stage S135: After atmospheric pressure restoration stage S130 is performed, atmospheric pressure maintenance stage S135 can be carried out; after the interior of the pressure chamber 10 is restored to atmospheric pressure, this state (atmospheric pressure state) is to be maintained for a certain time. Such stage is for mitigating the impact on the tissues of the fruits or vegetables caused by a change in pressure during atmospheric pressure restoration stage S130. However, in the present invention, as described in the part of atmospheric pressure restoration stage S130 above, the atmospheric pressure restoration stage is relatively leisurely performed, and all of the fruits or vegetables to be processed are processed immersed in an aqueous solution. Thus, even when the pressure changes in the atmospheric pressure restoration stage, a change or deformation of the tissues of the fruits or vegetables due to the change in pressure rarely occurs, and even when a minor change or deformation occurs, most of the change or deformation is restored while atmospheric pressure restoration stage S130 is performed.

For these reasons, the effect of the present invention can be achieved even when atmospheric pressure maintenance stage S135 is omitted (0 seconds) or performed only for a very short time (of less than 10 seconds).

Number of times that the main processing stages are performed: In the simultaneous transfer method, processes regarded as the main processing stages—from low-vacuum entry stage S120 to atmospheric pressure restoration stage S135, ranging from S120-S125-S130-S135—are performed once or more. The number of times the processes are performed may vary according to the characteristics of fruits or vegetables to be processed. For embodiment, in the case of tomatoes, cherry tomatoes, cucumbers, or the like which have relatively soft tissues, the processes may be performed only one time, and in the case of fruits vegetables which have hard tissues, the processes may be performed more than one time.

In the case of the method of the present invention, the main processing stages may be performed more than the number of times described above, but in this case, processing takes excessive time, reducing the processing efficiency, and also causes the risk of damage to the epidermis and internal tissues of fruits or vegetables to be processed. Therefore, in the case of fruits or vegetables such as tomatoes, cherry tomatoes, cucumbers, or the like which have weak (soft) tissues, the main processing stages or the atmospheric pressure restoration stage are performed within the above number of times, and in the case of fruits or vegetables such as apples or kiwis which have hard inner or epidermal tissues, or when the amount of infiltration needs to be further increased, the main processing stages or the atmospheric pressure restoration stage may be performed more than the above set number of times (for embodiment, three or more times).

Opening and taking-out stage S190: After all of the stages up to the atmospheric pressure maintenance stage S135 are performed, opening and taking-out stage S190 of opening the pressure cover 11 and taking out the immersion tank 20—in which all of the fruits or vegetables and the aqueous solution of the useful ingredients are contained—to the outside is performed. That is, after all certain processes are completed in the pressure chamber 10, the immersion tank 20 in which all of the fruits or vegetables and the aqueous solution are contained is taken out to the outside.

After such stage S190 is performed, the aqueous solution of the useful ingredients is drained from the immersion tank 20 taken out to the outside of the pressure chamber, and the processed fruits or vegetables are subjected to cleaning and drying stages.

As described above, in the present invention, processes from low-vacuum entry stage S120 to atmospheric pressure maintenance stage S135 may be performed one or more times. The number of times such stages are performed varies according to types of fruits or vegetables to be processed and to the state of tissues. In the case of fruits or vegetables into which useful ingredients infiltrate relatively easily, the stages may be performed for a short time or a small number of times, but to process fruits or the like which have hard tissues, the stages should be performed for a longer time or a greater number of times.

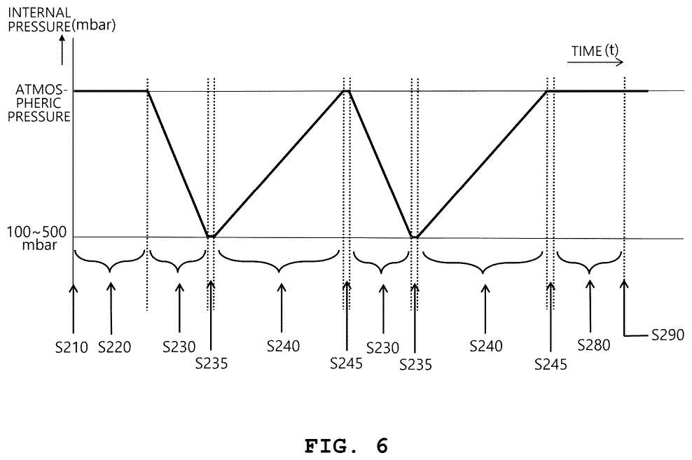

Next, the contents of a sequential supply method will be described. The contents of a method of infiltrating useful ingredients into fruits or vegetables performed in the sequential supply method will be described with reference to FIGS. 6 to 10.

As described above, the sequential supply method is classified into a later solution supply method and an early solution supply method.

The later solution supply method is the method of first taking the immersion tank 20 in which fruits or vegetables are contained into the pressure chamber and then supplying an aqueous solution into the pressure chamber. The early solution supply method is the method of first supplying an aqueous solution into the pressure chamber and then supplying fruits or vegetables into the pressure chamber.

The early solution supply method is a method of first supplying the aqueous solution into the pressure chamber, and then supplying the fruits or vegetables into the pressure chamber. The early solution supply method may be further classified into early solution supply method 1, early solution supply method 2, and early solution supply method 3 according to the order in which the aqueous solution, the fruits or vegetables, and the immersion tank are supplied (provided or taken) into the pressure chamber.

Early solution supply method 1 is a method of supplying the aqueous solution into the pressure chamber 10 and then taking the immersion tank 20, in which the fruits are contained, into the pressure chamber to perform processing according to a method of the present invention.

Early solution supply method 2 is a method of, after taking the empty immersion tank 20 into the pressure chamber 10, supplying the aqueous solution into the pressure chamber 10, and then supplying the fruits or vegetables into the pressure chamber to perform processing according to a method of the present invention.

Early solution supply method 3 is a method of, after first supplying the aqueous solution into the pressure chamber, taking the empty immersion tank into the pressure chamber, and then supplying the fruits into the pressure chamber to perform processing according to a method of the present invention.

In the later solution supply method and the early solution supply method of the sequential supply method, an aqueous solution of useful ingredients stored in the aqueous solution storage tank 50 should be supplied into the pressure chamber 10, and the solution supply pump 60 and the solution supply valve 61 operate under the control of the control unit 70 to supply the aqueous solution. The aqueous solution should be supplied such that all of the fruits or vegetables contained in the immersion tank 20 inside the pressure chamber 10 may be immersed therein.

FIG. 2 is a drawing of a configuration embodiment of the apparatus used in the later solution supply method. Although the anti-floating portion is not shown in the drawing, even in such method, a component identical to or similar to the anti-floating portion 1 shown in FIG. 1 or 3 may be used. An aqueous solution of useful ingredients should be supplied up to a water level in contact with the anti-floating portion such that all of fruits or vegetables are immersed in the aqueous solution.

In the case of the apparatus used in the later solution supply method, an installation position of the pressure cover 11 may be selected relatively freely. That is, the pressure cover may be installed on a side surface, a front surface, or an upper portion of the pressure chamber 10 to constitute the apparatus.

An apparatus used in the early solution supply method may have, for embodiment, a configuration as shown in FIG. 4. The apparatus of FIG. 4 is different from the apparatus of FIG. 2 in that the pressure cover 11 is formed on an upper portion of the pressure chamber 10.

As for the sequential supply method performed using the apparatus with configuration as shown in FIG. 2 or 4, the following stages are performed.

First, in the case of the later solution supply method, fruits or vegetables are processed by performing stages with contents shown in FIG. 6 and those described below.

Taking-in and sealing stage S210: A stage first performed in the sequential supply method is the taking-in and sealing stage S210 of, after opening the pressure cover 11, transferring (loading) the immersion tank 20—in which only fruits or vegetables are contained—into the pressure chamber and closing the pressure cover. In the sequential supply method, the immersion tank 20 in which only the fruits or vegetables are contained is taken into the pressure chamber 10, and thus there is an advantage in that the weight of the immersion tank is relatively light, which makes it easy to transfer the immersion tank.

Aqueous solution supply stage S220: After the taking-in and sealing stage S210 is performed, aqueous solution supply stage S220 of supplying an aqueous solution of useful ingredients into the pressure chamber 10 is performed. In such stage, the aqueous solution is supplied into the pressure chamber 10. The aqueous solution of the useful ingredients should be supplied to flow into the immersion tank 20 taken into the pressure chamber in advance such that all of the fruits or vegetables contained in the immersion tank 20 are immersed in the aqueous solution of the useful ingredients. The aqueous solution of the useful ingredients flows into the immersion tank 20 through the plurality of through-holes formed in the side surface and bottom of the immersion tank 20.

Low-vacuum entry stage S230, low-vacuum maintenance stage S235, atmospheric pressure restoration stage S240, and atmospheric pressure stage S245: After the aqueous solution supply stage S220 is performed, low-vacuum entry stage S230, low-vacuum maintenance stage S235, atmospheric pressure restoration stage S240, and atmospheric pressure maintenance stage S245 are sequentially performed. Such stages may be the most important stages of infiltrating useful ingredients into fruits or vegetables and may also be referred to as the main processing stages.

In the case of the later solution supply method, the same contents as low-vacuum entry stage S120 of the simultaneous transfer method described above are performed in low-vacuum entry stage S230, and the same contents as low-vacuum maintenance stage S125 of the simultaneously transfer method are performed in low-vacuum maintenance stage S235. In addition, the same contents as atmospheric pressure restoration stage S130 of the simultaneous transfer method are performed in atmospheric pressure restoration stage S240, and the same contents as atmospheric pressure maintenance stage S135 of the simultaneous transfer method are performed in atmospheric pressure maintenance stage S245.

That is, a method of infiltrating useful ingredients for the human body according to the present invention is classified into processing methods of the simultaneous transfer method and the sequential supply method according to the order of taking the immersion tank in and the type of the immersion tank, but contents performed in the most important stages from low-vacuum entry stage S230 to atmospheric pressure maintenance stage S245 are substantially the same in the two methods.

Number of times the main processing stages are performed: In the sequential supply method, processes from low-vacuum entry stage S230 to atmospheric pressure restoration stages S245 corresponding to the main processing stages, that is, processes of S230-S235-S240-S245 are performed one or more times. In the sequential supply method, as described in the part of the above simultaneous transfer method, the number of times such stages are performed may vary according to the characteristics of fruits or vegetables to be processed.

Even in the case of the later solution supply method, as described in the previous section regrading atmospheric pressure restoration stage S130 of the simultaneous transfer method, the main processing stages are performed one or more times according to the atmospheric pressure restoration time applied to atmospheric pressure restoration stage S130 for useful ingredients to infiltrate into fruits or vegetables. Even in this method, the number of times that the main processing stages are performed varies according to the types of fruits or vegetables to be processed, the state of tissues, and the purpose of processing.

Aqueous solution drain stage S280: After atmospheric pressure maintenance stage S245, aqueous solution drain stage S280 of draining the aqueous solution of the useful ingredients supplied into the pressure chamber 10 to the outside is performed. Aqueous solution drain stage S280 is applied to the sequential supply method, and in such stage, the drain valve 101 is opened under the control of the control unit 70 to drain the aqueous solution of the useful ingredients to the outside. The drain valve 101 may also be provided to be manually operated. When a large-capacity pressure chamber 10 is used, the drain pump 100 may be installed along with the drain valve 101 to drain the aqueous solution.

Opening and taking-out stage S290: After aqueous solution drain stage S280 is performed, opening and taking-out stage S290 is carried out, which is a stage of opening the pressure cover 11 and transferring (unloading) the immersion tank 20—in which only the fruits or vegetables are contained—to the outside of the pressure chamber.

After such stage S290 is performed, the processed fruits or vegetables are subjected to cleaning and drying processes.

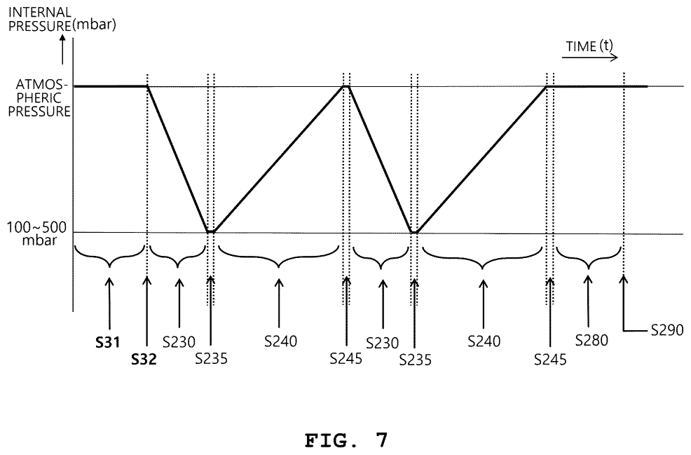

Second, early solution supply method 1 is a method of first supplying an aqueous solution into the pressure chamber 10, and then taking the immersion tank 20, in which fruits or vegetables are contained, into the pressure chamber to process the fruits or vegetables. Stages with the contents shown in FIG. 7 and described below are performed.

Aqueous solution supply stage S31: In this method, aqueous solution supply method S31 of supplying an aqueous solution of useful ingredients into the pressure chamber 10 is first performed. In such stage, the aqueous solution is supplied into the pressure chamber 10. The aqueous solution should be supplied such that all of the fruits or vegetables, which are contained in the immersion tank 20 are to be taken into the pressure chamber in a subsequent stage, are immersed in the aqueous solution of the useful ingredients. The aqueous solution of the useful ingredients flows into the immersion tank 20 through the plurality of through-holes formed in the side surface and the bottom of the immersion tank 20.

Taking-in and sealing stage S32: After aqueous solution supply stage S31 is performed, taking-in and sealing stage S32 of transferring (loading) the immersion tank 20—in which the fruits or vegetables are contained—into the pressure chamber and closing the pressure cover is performed. This method also takes the immersion tank 20—in which the fruits or vegetables are contained—into the pressure chamber 10.

Main processing stages: In the early solution supply method, the main processing stages among stages performed after taking-in and sealing stage S32 are the same as those in the later solution supply method.

That is, contents performed from low-vacuum entry stage S230 to atmospheric pressure maintenance stage S245 in the early solution supply method are the same as contents performed in processes from low-vacuum entry stage S230 to atmospheric pressure maintenance stage S245 in the later solution supply method.

Aqueous solution drain stage S280 and opening and taking-out stage S290: After all of the main processing stages are performed, aqueous solution drain stage S280 of draining the aqueous solution inside the pressure chamber is performed. Then the opening and taking-out stage S290 is performed, which is a stage of opening the pressure cover 11 and transferring (unloading) the immersion tank 20 containing only fruits or vegetables to the outside of the pressure chamber.

For reference, although FIG. 7 is expressed to superficially look identical to FIG. 5, preparation stage (PS) of FIG. 5 and taking-in and sealing stage S110 of FIG. 5 are respectively different from aqueous solution supply stage S31 of FIG. 7 and taking-in and sealing stage S32 of FIG. 7 in performed contents. That is, in preparation stage (PS) of the simultaneous transfer method shown in FIG. 5, the aqueous solution is supplied to the immersion tank from the outside, and then the immersion tank is transferred into the pressure chamber. However, in aqueous solution supply stage S31 of early solution supply method 1 shown in FIG. 7, the aqueous solution is supplied directly into the pressure chamber. In taking-in and sealing stage S110 of FIG. 5, the immersion tank 20 in which all of the fruits or vegetables and the aqueous solution are contained is transferred into the pressure chamber 10 and then the pressure cover 11 is closed, but the taking-in and sealing stage S32 of FIG. 7 transfers the immersion tank 20 that contains only fruits or vegetables into the pressure chamber 10, after which the pressure cover 11 is closed.

Here, let us compare FIG. 5 that shows the stages of the simultaneous transfer method, FIG. 6 which portrays the stages of the later solution supply method, and FIG. 7 that depicts early solution supply 1. First, in FIG. 5 (simultaneous transfer method), the immersion tank in which all of the fruits or vegetables and the aqueous solution of the useful ingredient are contained is taken into the pressure chamber 10 to process the fruits or vegetables.

In FIG. 6 (later solution supply method of the sequential supply method), after the immersion tank in which only the fruits or vegetables are contained is first taken into the pressure chamber 10, the aqueous solution of the useful ingredients is supplied to allow the fruits or vegetables contained in the immersion tank to be immersed in the aqueous solution, and then the fruits or vegetables are processed.

In FIG. 7 (early solution supply method 1 of the sequential supply method), after the aqueous solution of the useful ingredients is first supplied into the pressure chamber 10, the immersion tank in which only the fruits or vegetables are contained is taken into the pressure chamber 10 to allow the fruits or vegetables contained in the immersion tank to be immersed in the aqueous solution, and then the fruits or vegetables are processed.

Meanwhile, unlike the early solution supply method 1 which runs the main processing stages first, then aqueous solution drain stage S280, and next the opening and taking-out stage S290, the present invention can be constructed so that the opening and taking-out stage is first performed, followed by the aqueous solution drain stage.

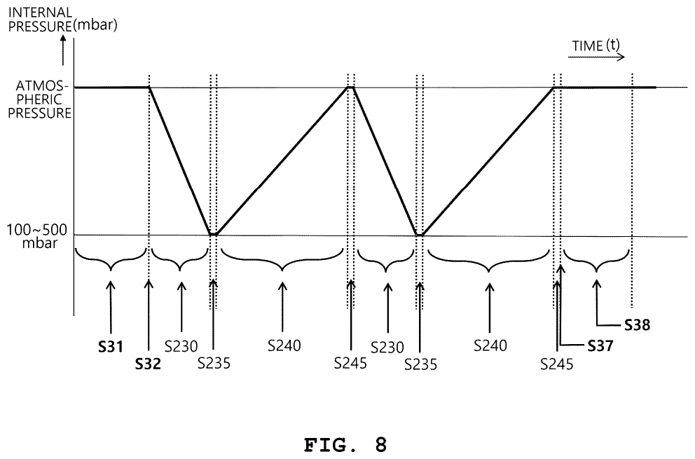

As shown in FIG. 8, the present invention can be built so that the opening and taking-out stage S37 is first performed and the aqueous solution drain stage S38 second. However, such method is one in which the order of the previous stages among the stages of early solution supply method 1 is changed and corresponds to another embodiment of early solution supply method 1.

FIG. 8 shows processing stages according to another embodiment of early solution supply method 1 and shows a stage of first taking out the immersion tank, in which fruits or vegetables are contained, to the outside of the pressure chamber, and then draining an aqueous solution of useful ingredients. When processed through such method, the fruits or vegetables are processed in a state of being immersed in the aqueous solution during the entire process. Therefore, the fruits or vegetables may be processed in a state in which tissues thereof are stable.

Second, early solution supply method 2 involves the following process: after taking the empty immersion tank 20 into the pressure chamber 10, aqueous solution of useful ingredients is supplied into the pressure chamber 10, and then fruits or vegetables are supplied into the pressure chamber to perform processing according to the present invention.

Early solution supply method 2 is a method in which the immersion tank and the aqueous solution are taken and supplied into the pressure chamber where fruits or vegetables are supplied (dropped) into the aqueous solution of the immersion tank and processed. It is a method in which, after processing, the processed fruits or vegetables are taken out to the outside of the pressure chamber using the immersion tank 20.

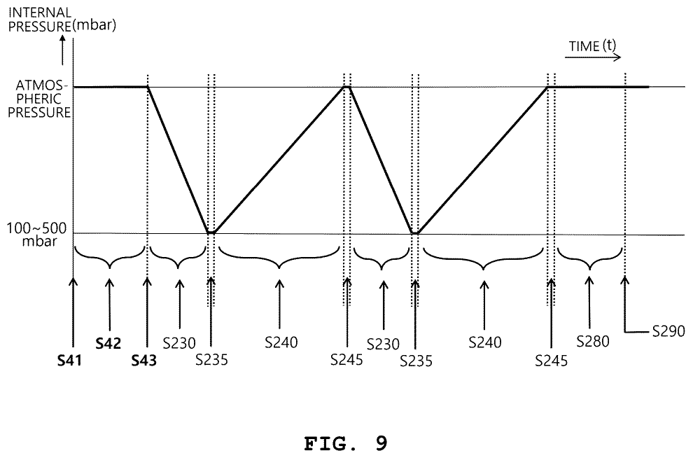

Early solution supply method 2 includes the contents shown in FIG. 9 and the following stages.

Immersion tank taking-in stage S41: In this method, the immersion tank taking-in stage S41 of taking the empty immersion tank 20 into the pressure chamber 10 is first performed.

Aqueous solution supply stage S42: After the immersion tank taking-in stage S41 is performed, aqueous solution supply stage S42 of supplying an aqueous solution of useful ingredients into the pressure chamber 10 is performed.

Supply and sealing stage S43: After aqueous solution supply stage S42 is performed, the supply and sealing stage S43 is run, which involves the supplication of fruits or vegetables into the pressure chamber 10 and the sealing of the pressure cover 11.

In early solution supply method 2, after supply and sealing stage S43 is performed, the main processing stages of the present invention—stages from low-vacuum entry stage S230 to atmospheric pressure maintenance stage S245—are performed.

In early solution supply method 2, after the main processing stages are performed, aqueous solution drain stage S280 and then the open and taking-out stage S290 are performed.

Meanwhile, as described in the part related to another embodiment of early solution supply method 1 above, early solution supply method 2 may be performed by applying another embodiment in the same manner as above. Another embodiment of early solution supply method 2 has a configuration in which, after the main processing stages are performed, an open and taking-out stage is first performed, and then an aqueous solution drain stage is performed.

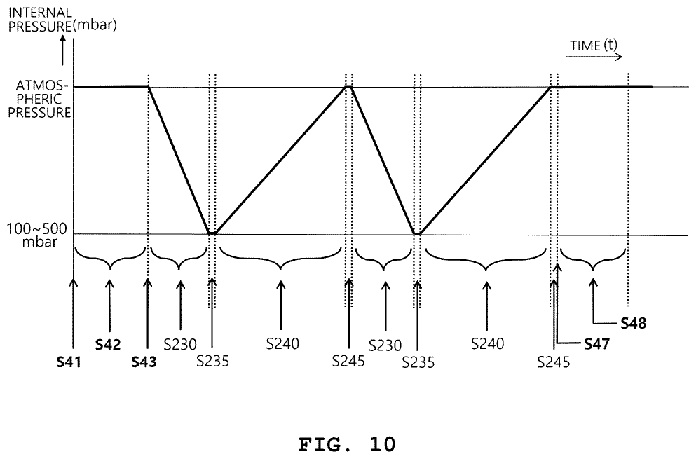

FIG. 10 is a graph showing the processing stages according to another embodiment of early solution supply method 2. When fruits or vegetables are processed according to the embodiment, since the immersion tank in which the processed fruits or vegetables are contained is first taken out to the outside of the pressure chamber and then an aqueous solution of useful ingredients is drained, the fruits or vegetables are immersed in the aqueous solution during the process of performing all stages. Therefore, the fruits or vegetable may be processed in a state in which tissues thereof are stable.

Third, early solution supply method 3 involves first supplying an aqueous solution of useful ingredients into the pressure chamber 10, taking the empty immersion tank 20 into the pressure chamber 10, and then supplying fruits or vegetables into the pressure chamber to perform processing according to the present invention.

Early solution supply method 3 is a method which supplies (drops) fruits or vegetables into the aqueous solution of the immersion tank to process them while the aqueous solution and the immersion tank 20 are supplied and taken into the pressure chamber. After processing the fruits or vegetables, they are taken out to the outside of the pressure chamber using the immersion tank.

Early solution supply method 3 is different from early solution supply method 2 only in the order of taking the immersion tank in and supplying the aqueous solution and is a method of processing fruits or vegetables substantially in the same manner as in early solution supply method 2. In addition, even in the case of early solution supply method 3, like early solution supply method 1 and early solution supply method 2, another embodiment may be applied, one with a configuration in which an opening and taking-out stage is performed after the main processing stages are performed, after which an aqueous solution drain T is performed, that is, another embodiment of early solution supply method 3.

Contents performed after the main processing stages in another embodiment of early solution supply method 3 is the same as contents performed after the main processing stages in another embodiment of early solution supply method 2 described above, and a description thereof is omitted.

The contents processed for each stage performed in early solution supply method 3 and another embodiment of early solution supply method are the same as early solution supply method 2 and are different from those of early solution supply method 2 only in the order of taking the immersion tank in and supplying the aqueous solution, and thus a description thereof will be omitted in the drawing.

In the present invention, stages included in the various embodiments above are performed for the useful ingredients to infiltrate into the fruits or vegetables.

Meanwhile, a method of the present invention has a configuration in which a low vacuum in a range of 100 to 500 mbar is selected as a range of specific pressure in a pressure range of 10 to 500 mbar which is a low vacuum pressure range applied to the Earlier Application of the applicant, and low-vacuum entry stages S120, S230 and low-vacuum maintenance stage S125, S235 are performed in the range of specific pressure.

The Earlier Application of the applicant provides a configuration in which, after the immersion tank where only fruits or vegetables are contained is transferred into the pressure chamber in which an aqueous solution is not supplied into the pressure chamber (a state in which the fruits or vegetables are placed in the air), the inside of the pressure chamber is depressurized to a low vacuum of 10 to 500 mbar to then maintain such a state for a time of 10 seconds to 5 minutes, and then the same maintenance time as above is given even after a pressurizing stage.

On the other hand, the present invention provides a configuration in which all processes of the main processing stages are performed in a state in which all of the fruits or vegetables are immersed in an aqueous solution and in which, after a pressure chamber is sealed, the inside thereof is depressurized to enter a range of specific vacuum pressure, that is, a low vacuum state of 100 to 500 mbar (perform a low-vacuum entry stage), and then maintain the low vacuum state for a short time of less than 10 seconds. Then a stage of restoring atmospheric pressure (atmospheric pressure restoration stage) is performed.

Meanwhile, in the present invention, a range of low vacuum pressure which is more preferable than the above-described range of 100 to 500 mbar is from 100 to 400 mbar, a still more preferable range is from 100 to 300 mbar, and the most preferable range is from 100 to 200 mbar.

In addition, the present invention is different from the Earlier Application in that the pressurizing stage adopted in the Earlier Application is not used. This is because the present invention is an invention having a key configuration in which an air portion inside the pressure chamber 10 is allowed to enter a low vacuum state in such a pressure range, and then, in a process of releasing the low vacuum state and restoring atmospheric pressure, useful ingredients are allowed to infiltrate into the fruits or vegetables.

In addition, another difference between the present invention and the Earlier Application is the difference in maintenance time given after main processing stages are performed. In the Earlier Application, after each of the main processing stages of infiltrating useful ingredients (for embodiment, in the case of claim 1, stage 20, stage 40, stage 151, stage 152, stage 161, and stage 162) is performed, the pressure state of each stage is maintained for a certain time (of 10 seconds to 5 minutes). On the other hand, the present application provides a configuration in which the maintenance time is omitted only after the low-vacuum entry stage S120 and atmospheric pressure restoration stage S130, or a subsequent stage is performed after a short maintenance time of less than 10 seconds. Therefore, in the present invention, the problem that a processing time is increased due to the maintenance time rarely occurs.

To apply the present invention, the applicant has conducted an experiment for limiting a low vacuum pressure range and an atmospheric pressure restoration time in which useful ingredients may effectively infiltrate into the fruits or vegetables, and in particular, has conducted an experiment using tomatoes to obtain results shown below. The experiment has been conducted in a state in which tomatoes are immersed in an aqueous solution of useful ingredients, and to easily identify the state of infiltration, food coloring has been used as the useful ingredient. The contents of the experiment conducted by the applicant are as follows.

1. Degree of infiltration of useful ingredients during low-vacuum entry stage: During a low-vacuum entry stage of discharging air such that the inside of the pressure chamber entered a low vacuum state, infiltration of useful ingredients rarely occurred. In the low-vacuum entry stage of discharging air inside the pressure chamber to the outside, tissues of fruits or vegetable were affected to expand to the outside, and as a result, the useful ingredients rarely infiltrated into the fruits or vegetables or did so to a very small extent. This showed that the infiltration of the useful ingredients rarely occurred in such a stage.

2. Difference in infiltration effect according to low-vacuum entry time: In a method of the present invention, since processing was performed in a state in which all of the tomatoes were immersed in the aqueous solution and a low vacuum pressure was applied, there was almost no damage to tissues of the tomatoes due to the vacuum pressure and there was almost no difference in infiltration effect according to a difference in low vacuum entry time.

3. Degree of infiltration of useful ingredients during maintenance stage after low vacuum state was reached: After a level of a low vacuum state set in the present invention was reached, an amount of infiltration of the useful ingredients during a time for which the low vacuum state maintained was also insignificant. Therefore, since a low vacuum maintenance time was not given after the low-vacuum entry stage or since the low vacuum state was maintained for a short time required for operating an apparatus, the efficiency of processing could be increased.

4. Degree of infiltration of useful ingredients during atmospheric pressure restoration stage: In this experiment related to the present invention, in the atmospheric pressure restoration stage, a process of restoring the pressure to atmospheric pressure after the interior of the pressure chamber 10 reaches the set low vacuum state and the external air is allowed into the pressure chamber, the amount of infiltration of the useful ingredients was the highest. In addition, when the inside of the pressure chamber was restored to atmospheric pressure while external air evenly and gradually supplied, the useful ingredients infiltrated best.

1) Degree of infiltration of useful ingredients: It was confirmed that the infiltration effect varied according to the time for which a low vacuum was restored to atmospheric pressure. As the atmospheric pressure restoration time increased, the amount of infiltration of the useful ingredients increased. Meanwhile, when the atmospheric pressure restoration time was increased to exceed 10 minutes, the amount of infiltration of the useful ingredients further increased, but problems of too many useful ingredients infiltrating the tomatoes and its tissues weakening or changing occurred due to the excessive amount of infiltration of the useful ingredients, reducing the marketability of products.

2) Number of times that the atmospheric pressure restoration stage was performed: After low-vacuum entry stage S120 or S230 was performed, when an atmospheric pressure restoration time of 10 minutes or less was given, a level of infiltration that met an expected level was achieved. When an atmospheric pressure restoration time of 5 minutes or less was given, there were cases in which the useful ingredients were not absorbed sufficiently according to the targets to be processed. In this case, when the atmospheric pressure restoration stage was further performed, that is, when low-vacuum entry stage S120, S230 and atmospheric pressure restoration stage S130, S240 were further performed, the useful ingredients infiltrated well.

The atmospheric pressure restoration time may be shortened, or the number of times that the atmospheric pressure restoration stage is performed may be increased to increase the amount of infiltration. However, when the main processing stages were performed multiple times, a lot of time was required for operating an apparatus, which reduced the overall processing efficiency.

In the case of tomatoes, it was preferable to perform the atmospheric pressure restoration stage one time for 30 seconds to 10 minutes, twice for 30 seconds to 7 minutes, or three times for 30 seconds to 5 minutes. When the atmospheric pressure restoration time was set as a short time of 3 minutes or less, the amount of infiltration was small, and when such stage was performed more than three times, the overall processing time was increased, which reduced processing efficiency. On the other hand, as for fruits or vegetables with hard tissues or epidermis and when it was desired to further increase the amount of infiltration of the useful ingredients, it was necessary to give more atmospheric pressure restoration time or to perform the atmospheric pressure restoration stage three or more times.

3) Relationship between low-vacuum entry time and atmospheric pressure restoration time: In the method of the present invention, there was no direct relationship between the time to reach a low vacuum state (time of the low-vacuum entry stage or time to reach a low vacuum) and the atmospheric pressure restoration time. The time to reach a low vacuum varies according to the capacity or performance of a vacuum pump used in an apparatus. However, when a typical apparatus is used, it takes about 30 to 90 seconds to reach a low vacuum. Meanwhile, as described above, the atmospheric pressure restoration time applied to the present invention was a time of 30 seconds to 10 minutes, 30 seconds to 7 minutes, or 30 seconds to 5 minutes, and thus, in the present invention, it was shown that the atmospheric pressure restoration stage was preferably performed for a time that was about 5 to 10 times longer than a time of the low-vacuum entry stage.

5. Range of applied low vacuum pressure

1) When a low vacuum pressure inside the pressure chamber exceeded 500 mbar (vacuum gauge pressure of −500 or −0.5 bar), the useful ingredients rarely infiltrated into the tomatoes. When a pressure inside the pressure chamber ranges from 500 mbar to atmospheric pressure, other than natural infiltration due to osmotic pressure, the amount of infiltration due to technical factors of the invention was very small.

2) When a low vacuum pressure inside the pressure chamber is in a range of 100 mbar (vacuum gauge pressure of −900 or −0.9 bar) to 500 mbar, as the vacuum condition heightened (as the pressure inside the pressure chamber was further lowered), there was an effect of increasing the amount of infiltration of the useful ingredients. That is, when a range of low vacuum pressure was from 100 to 500 mbar, an infiltration effect expected in the present invention occurred. However, it was shown that a more desirable range of low vacuum pressure was from 100 to 400 mbar, a still more preferable range of low vacuum pressure from 100 to 300 mbar, and the most desirable range from 100 to 200 mbar.

When a low vacuum pressure inside the pressure chamber was further lowered to 100 mbar or less (vacuum gauge pressure of −900 or −0.9 bar), the amount of infiltration of the useful ingredients was increased, but an excessive amount of infiltration of the useful ingredients damaged the internal tissues of fruits or vegetables, resulting in the side effects of lowering the marketability of processed products and shortening a distribution period thereof. In addition, it took a lot of time to reach such a high degree of vacuum, and the amount of energy (power) requirement considerably increased.

The present invention is summarized as follows in relation to the above experiment.

First, in the present invention, when the range of low vacuum pressure applied to the inside of the pressure chamber 10 for the useful ingredients to effectively infiltrate into fruits or vegetables is from 100 to 500 mbar, the infiltration effect expected in the present invention occurs. A more preferable range of low vacuum pressure than such a range is from 100 to 400 mbar, a still more preferable range from 100 to 300 mbar, and the most preferable range from 100 to 200 mbar.

Next, in the present invention, the time (atmospheric pressure restoration time) taken to perform an atmospheric pressure restoration stage, which is a stage in which the infiltration of useful ingredients is most active, is in the range of 30 seconds to 10 minutes, 30 seconds to 7 minutes, or 30 seconds to 5 minutes. In the present invention, when the atmospheric pressure restoration stage was performed one time for an atmospheric pressure restoration time of 30 seconds to 10 minutes, twice for an atmospheric pressure restoration time of 30 seconds to 7 minutes, or three or more times for an atmospheric pressure restoration time of 30 seconds to 5 minutes, the useful ingredients effectively infiltrated into the fruits or vegetables.

In addition, in the present invention, the atmospheric pressure restoration stage was performed for a time that was about 5 to 10 times longer than the time of a low-vacuum entry stage to allow the useful ingredients to infiltrate the fruits or vegetables effectively.

When fruits or vegetables are processed according to a method of the present invention including the above-described stages, the following effects can be expected.

First, in the present invention, all stages that have sweet ingredients or useful ingredients for the human body to infiltrate fruits or vegetables are performed in a state in which all fruits or vegetables are immersed in an aqueous solution of useful ingredients. Since water which has a very stable molecular structure, even when the pressure applied to the water changes, there is almost no change in its volume. Therefore, when fruits or vegetables are processed in a state in which all of the fruits or vegetables are immersed in an aqueous solution of useful ingredients, even when the pressure of the external air changes, there is almost no change in volume of the fruits or vegetables. Therefore, fruits or vegetables processed through the method of the present invention can maintain a stable state during the processing stage, thereby effectively preventing damage to tissues.

The present invention uses a low vacuum in a range of specific pressure as described above. And even without the use of a stage of pressurizing the inside of the pressure chamber to a pressure higher than or equal to atmospheric pressure, useful ingredients can more effectively infiltrate than the Earlier Application. Damage to tissues of fruits or vegetables can be prevented, and energy costs required for processing fruits or vegetables can be reduced.

In the case of the present invention, a infiltration effect can be achieved even while omitting a maintenance stage performed after the main processing stages or while shortening the maintenance time to a very short time of less than 10 seconds. Thus, a time taken to process fruits or vegetables can be shortened, and processing costs can be reduced.

In the present invention, while the pressure inside the pressure chamber 10 applied to a low-vacuum entry stage is to be set at a low vacuum pressure in a specific range, effective infiltration of the useful ingredients into fruits or vegetables can be expected by applying a low vacuum pressure range that excludes a pressure range where the infiltration effect is insignificant due to significantly low degree of vacuum and where the tissues of fruits or vegetables are damaged, reducing the marketability of products as well as the distribution period and increasing the energy consumption.

In the present invention, as compared to most of the relates arts as well as a processing method according to the Earlier Application of the applicant, damage to the epidermis or internal tissues of fruits or vegetables can be reduced, thereby allowing the freshness of the fruits or vegetables to be maintained longer after processing.

As the method of the present invention has been described in detail, the technical idea of the present invention is not limited to the contents described above but includes embodiments that are identical or similar to the technical idea of the present invention and can be applied without any special technical changes by those skilled in the art to which the present invention pertains. In addition, anything similar or equivalent to the technical idea of the present invention described in the claims should be construed as falling within the scope of the present invention.

### INDUSTRIAL APPLICABILITY

The present invention relates to a method of processing fruits or vegetables such that sweet ingredients or useful ingredients for the human body effectively infiltrate fruits or vegetables and to an apparatus used in the method. That is, the present invention relates to a technology in which the following stage is performed once or more: while all fruits or vegetables to be processed are immersed in an aqueous solution of useful ingredients supplied into a pressure chamber, the air inside the pressure chamber is discharged to allow the inside to enter a low pressure state at a level according to the present invention and then maintain such a state for a certain time, after which the internal air is discharged to allow the internal pressure to become atmospheric pressure. This allows the sweet ingredients or useful ingredients to effectively infiltrate into the fruits or vegetables. In addition, the present invention relates to a technology capable of effectively preventing damage to the epidermis and internal tissues of fruits or vegetables while the fruits or vegetables are processed.

Therefore, the present invention corresponds to a technology that has industrial applicability.

1. A method of infiltrating sweet ingredients or useful ingredients for the human body into fruits or vegetables, which is a method of processing fruits or vegetables using an immersion tank (20) of which side surfaces and the bottom are all sealed, wherein the fruits or vegetables are processed while immersed in an aqueous solution of useful ingredients, comprises:
a preparation stage of supplying the aqueous solution of the useful ingredients into the immersion tank (20) such that all of the fruits or vegetables contained in the immersion tank 20 are immersed in the aqueous solution of the useful ingredient;
a taking-in and sealing stage of, after performing the preparation stage, opening a pressure cover (11) of a pressure chamber (10) to take the immersion tank (20) with all of the fruits or vegetables and the aqueous solution of the useful ingredients into the pressure chamber (10), and then closing the pressure cover (11) to seal the pressure chamber;
a low-vacuum entry stage of, after the taking-in and sealing stage, operating a vacuum pump (40) to reduce the pressure such that the inside of the pressure chamber (10) enters a low vacuum state in a range of specific pressure;
a low-vacuum maintenance stage of maintaining the low vacuum state at a specific pressure, which is reached as a result of performing the low-vacuum entry stage for a certain time;
an atmospheric pressure restoration stage of, after the low-vacuum maintenance stage, allowing external air to flow into the pressure chamber (10) to allow the inside of the pressure chamber (10) to be restored to an atmospheric pressure state;
an atmospheric pressure maintenance stage of, after performing the atmospheric pressure restoration stage, maintaining the condition inside the pressure chamber (10) restored to an atmospheric pressure state for a certain time; and
an opening and taking-out stage of, after performing all stages up to the atmospheric pressure maintenance stage, opening the pressure cover (11) and taking out the immersion tank (20), in which all of the fruits or vegetables and the aqueous solution of the useful ingredients are contained,
wherein the specific pressure applied to the low-vacuum entry stage ranges from 140 to 500 mbar,
a maintenance time in each of the low-vacuum maintenance stage and the atmospheric pressure maintenance stage is in the range of 0 to less than 10 seconds, and
the low vacuum entry stage, the low-vacuum maintenance stage, the atmospheric pressure restoration stage, and the atmospheric pressure maintenance stage are performed one or more times.

2. (canceled)

3. (canceled)

4. (canceled)

5. A method of infiltrating sweet ingredients or useful ingredients for the human body into fruits or vegetables, which is a method of processing fruits or vegetables contained in an immersion tank (20) with many holes formed on the sides or on both the sides and the bottom, wherein the fruits or vegetables are processed while immersed in an aqueous solution of useful ingredients, comprises:
an immersion tank taking-in stage of taking the empty immersion tank (20) into a pressure chamber (10);
an aqueous solution supply stage of, after performing the immersion tank taking-in stage, supplying the aqueous solution of the useful ingredients into the pressure chamber (10);
a supplying and sealing stage of, after performing the aqueous solution supply stage, supplying the fruits or vegetables into the pressure chamber, and then sealing the pressure cover;
a low-vacuum entry stage of, after the supplying and sealing stage, operating a vacuum pump (40) to reduce a pressure such that an inside of the pressure chamber (10) enters a low vacuum state in a range of specific pressure;
a low-vacuum maintenance stage of maintaining the low vacuum state at the specific pressure, which is reached as a result of performing the low-vacuum entry stage for a certain time;
an atmospheric pressure restoration stage of, after the low-vacuum maintenance stage, allowing external air to flow into the pressure chamber (10) to allow the inside of the pressure chamber (10) to be restored to an atmospheric pressure state;
an atmospheric pressure maintenance stage of, after performing the atmospheric pressure restoration stage, maintaining the state inside the pressure chamber (10) restored to an atmospheric pressure state for a certain time;
an aqueous solution drain stage of, after the atmospheric pressure maintenance stage, draining the aqueous solution of the useful ingredients supplied into the pressure chamber (10) to the outside; and
an opening and taking-out stage of, after performing the aqueous solution drain stage, opening the pressure cover (11) and taking out the immersion tank (20) in which the fruits or vegetable are contained,
wherein the specific pressure applied to the low-vacuum entry stage ranges from 140 to 500 mbar,
a maintenance time in each of the low-vacuum maintenance stage and the atmospheric pressure maintenance stage is in a range of 0 to less than 10 seconds, and
the low vacuum entry stage, the low-vacuum maintenance stage, the atmospheric pressure restoration stage, and the atmospheric pressure maintenance stage are performed once or more.

6. (canceled)

7. (canceled)

8. (canceled)

9. The method of claim 1, wherein the specific pressure range reached through pressure reduction in the low-vacuum entry stage ranges from 140 to 400 mbar.

10. The method of claim 9, wherein the specific pressure range reached through the decompression in the low-vacuum entry stage ranges from 140 to 300 mbar.

11. The method of claim 10, wherein the specific pressure range reached through the decompression in the low-vacuum entry stage ranges from 140 to 200 mbar.

12. The method of claim 1, wherein the atmospheric pressure restoration stage is performed for a time of 30 seconds to 10 minutes.

13. The method of claim 12, wherein the atmospheric pressure restoration stage is performed for a time of 30 seconds to 7 minutes and is performed twice.

14. The method of claim 13, wherein the atmospheric pressure restoration stage is performed for a time of 30 seconds to 5 minutes and is performed three or more times.

15. The method of claim 9, wherein the atmospheric pressure restoration stage is performed for a time of 30 seconds to 10 minutes.

16. (canceled)

17. The method of claim 11, wherein the atmospheric pressure restoration stage is performed for a time of 30 seconds to 5 minutes and is performed three or more times.

18. An apparatus used for sweet ingredients or useful ingredients for the human body to infiltrate into the fruits or vegetables according to the method of any one of claims 1 to 8 comprise of the following:
a pressure chamber (10);
one or more immersion tanks (20) accommodated inside the pressure chamber (10);
an air pump (30) or air inflow valve (35) that operates to supply external air into the pressure chamber (10);
a vacuum pump (40) that operates to discharge air inside the pressure chamber (10) and allow the inside of the pressure chamber (10) to enter a low vacuum state in a range of specific pressure;
an aqueous solution storage tank (50) configured to store an aqueous solution of the useful ingredients that are to infiltrate the fruits or vegetables;
a solution supply pump (60) and a solution supply valve (61) configured to supply the aqueous solution stored in the aqueous solution storage tank (50) into the pressure chamber (10);
a pressure gauge (80) configured to display the pressure inside the pressure chamber;
a level sensor (90) configured to indicate the level of the aqueous solution of the useful ingredients supplied to the pressure chamber (10) or the immersion tank (20); and
a drain valve (101) that operates to drain the aqueous solution supplied into the pressure chamber (10),
wherein the solution supply valve (61) is connected to a solution supply nozzle (62) and is configured to supply the aqueous solution of the useful ingredients to each of the immersion tanks (20) accommodated inside the pressure chamber (10).

19. The apparatus of claim 18, wherein an anti-floating portion (21) is additionally provided at the upper portion of each of the immersion tanks (20) to allow all of the fruits or vegetables contained in the immersion tank to be immersed in the aqueous solution of the useful ingredients.

20. The method of claim 5, wherein the specific pressure range reached through pressure reduction in the low-vacuum entry stage ranges from 100 to 400 mbar.

21. The method of claim 20, wherein the specific pressure range reached through the decompression in the low-vacuum entry stage ranges from 100 to 300 mbar.

22. The method of claim 21, wherein the specific pressure range reached through the decompression in the low-vacuum entry stage ranges from 100 to 300 mbar.

23. The method of claim 5, wherein the atmospheric pressure restoration stage is performed for a time of 30 seconds to 10 minutes.

24. The method of claim 23, wherein the atmospheric pressure restoration stage is performed for a time of 30 seconds to 7 minutes and is performed twice.

25. The method of claim 24, wherein the atmospheric pressure restoration stage is performed for a time of 30 seconds to 5 minutes and is performed three or more times.

26. The method of claim 9, wherein the atmospheric pressure restoration stage is performed for a time of 30 seconds to 10 minutes.

27. The method of claim 22, wherein the atmospheric pressure restoration stage is performed for a time of 30 seconds to 5 minutes and is performed three or more times.
